(19) United States
(12) Patent Application Publication
(10) Pub. No.: US 2003/0108164 A1
(43) Pub. Date: Jun. 12, 2003

(54) Simultaneous, multiple digital presentation content block, channel independent presentation controller

(76) Inventors: Jeremy S. Laurin, Bath (CA); Lucio Agostini, Toronto (CA)

Correspondence Address: DOWELL & DOWELL PC, SUITE 309, 1215 JEFFERSON DAVIS HIGHWAY, ARLINGTON, VA, 22202

(21) Appl. No.: 10/022,431

(22) Filed: Dec. 20, 2001

Related U.S. Application Data
(63) Continuation-in-part of application No. 09/778,850, filed on Feb. 8, 2001.

(51) Int. Cl. H04M 1/64

(52) U.S. Cl. 379/88.01

(57) ABSTRACT

A presentation system has a presentation controller and a play back system for presenting multiple digital presentation blocks of content to multiple audiences simultaneously. The blocks are presented through multiple channels that are selectable by the audience. The blocks are presented through presentation contrivances such as headsets or speakers. The playback system may have a wireless transmission system such that the content in the blocks is transmitted wirelessly to the location of the audience. The channels of the playback system are addressable by the presentation controller. The presentation controller has a number of device definitions and pools of play list items, each play list items specifies one or more of the digital presentation blocks. Each device definition defines a group of one or more channels and defines a pool of play list items for playing to the defined group. The presentation controller is able to redefine the pool of a device definition. The channels are in devices and the device definitions define one or more channels within one or more devices. The presentation controller can play playlist items sequentially within a pool. The presentation controller can have context definitions that define a play list item for each pool, and can play the defined play list items concurrently for each context definition.

### This is a continuation-in-part application of U.S. patent application Ser. No. 09/778,850 filed Feb. 8, 2001.

### FIELD OF THE INVENTION

The present invention relates generally to the presentation of different presentation content to multiple audiences simultaneously. For example, a restaurant or bar may have audiences in multiple rooms that may wish to hear different presentations or, in this case, songs. As a further example, it may relate to tour presentations and, more particularly, to simultaneous multi language presentations.

### BACKGROUND OF THE INVENTION

There are many different applications for the presentation of multiple streams of audiovisual content to multiple audiences. For example, a tour may have audience members that speak different languages. Alternatively, a bar, restaurant or resort may have multiple rooms, or even multiple booths, that wish to hear different songs or types of music. Most often the requirement is for different audio content; however, different video content may be required as well. Many different methods and systems have been used for such applications. For example, in the tour industry multiple tape decks have been used to deliver commentary in different languages simultaneously. Each tape deck is dedicated to one language. The operator must interact with each cassette deck to control the functions.

Each tape contains a preset order of commentary. It is difficult and time consuming to skip forward or back through the commentaries.

The system that exists to deliver the commentary to the listening audience is a series of headphones that are hardwired into a patch bay that may be driven by distribution amplifiers. The wiring is likely complex and difficult to maintain.

CD players may be similarly used. In this case, skipping forward or back is not as difficult.

A single tape deck system may be used to deliver commentary in different languages in a sequential manner. For example, English is delivered first, French second, etc.

Clearly, this had the disadvantage of having to deliver a language to a global listening audience for which most of the commentaries are not understood. The time elapsed to deliver one commentary is a function of the number of languages supported.

The transmission system is likely in the form of a public address system.

Again, a CD player may be used in place of a tape deck.

As described in the single tape deck system, a PC may be used to deliver commentary in different languages in a sequential manner.

Clearly, this had the disadvantage of having to deliver a language to a global listening audience for which most of the commentaries are not understood. The time elapsed to deliver one commentary is a function of the number of languages supported.

The transmission system is likely in the form of a public address system.

Multiple cassette tape decks have also been used to deliver music of different styles simultaneously. Each tape deck is dedicated to one style of music. The operator must interact with each cassette deck to control the functions.

Each tape contains a preset order of music content. It is difficult and time consuming to skip forward or back through the content.

As for the multiple tape deck tour system, the system that exists to deliver the content to the listening audience is a series of speakers that are isolated in a room, and are hardwired into a patch bay that may be driven by distribution amplifiers. The wiring is likely complex and difficult to maintain.

Multiple compact disk decks have been used to deliver music of different styles simultaneously. This offers a little more flexibility than the tape deck solution in that CD cartridges may accommodate many CDs. The random shuffling feature offered on a CD player allows for a more “unpredictable” delivery of music.

Again, the operator must interact with each CD deck to control the functions. It is an object of the invention to address these or other problems associated with simultaneous presentation of content to multiple audiences.

### SUMMARY OF THE INVENTION

In a first aspect the invention provides a presentation controller for simultaneously playing a plurality of digital presentation blocks to one or more channels. Each channel drives one or more presentation contrivances. The presentation contrivances present to a plurality of audiences. The presentation controller has a plurality of device definitions and a plurality of pools of play list items. Each play list item specifies one or more play items. Each play item specifies one of the digital presentation blocks. Each device definition defines a group of one or more channels and defines a pool of play list items for playing to the defined group, and the presentation controller is able to redefine the pool of a device definition.

The channels may be contained within one or more devices, with each device definition defining a group of one or more channels by defining one or more channels within one or more devices.

The presentation controller may play play list items sequentially within a

pool. The presentation controller may have a plurality of context definitions. If so, each context definition defines a play list item for each pool, and the presentation controller plays concurrently the defined play list items for each context definition.

In a second aspect the invention provides a multi-channel transmission and receiving system for the broadcast of pre-programmed information in varied languages. Each pre-programmed language is digitized and saved as a data file that is called by a main program in a computer when required. The main program is programmed to respond to external or time events that determine which data files are to be used and output to a digital to analog converter and/or de-multiplexer. Each analog channel is sent to a transmitter tuned to a channel specific for the use of the analog signal, where transmitter outputs are combined via a tuned series of filters to an antenna. The receiver is portable, and designed to receive the transmitted frequencies and comprises a channel select switch in the receiver determines which of the transmitter frequencies to receive, and thereby determining which language to receive.

The computer may be controlled by specific GPS or location data that guides the computer program to select the appropriate files for that specific geographic zone or site.

The data files may be output to the computer port as serial data, wherein the serial data is re-programmed via means of digital signal processing and transmitted as Time Division Multiple Access via a spread -spectrum frequency hoping transmitter and wherein the receiver is cap able of receiving the wireless signal and de-coding the appropriate channel via a selector switch.

In a third aspect, the invention provides a presentation system having a plurality of digitized versions of a scene; one or more physical devices for playing digital content to one or more channels; and a presentation controller for directing respective digitized versions of the scene to a particular channel of a physical device for synchronized playing of the respective versions.

The presentation controller combines those versions that are directed to a particular physical device. The combination occurs at the time the versions are to be played.

In a fourth aspect the invention provides a presentation system having digital content arranged as a set of one or more scenes, each scene having one or more versions; one or more physical devices for playing digital content to one or more channels; and a presentation controller for directing respective versions of a scene to a particular channel of a physical device for synchronized playing of the respective versions. The presentation controller combines those versions that are directed to a particular physical device. The combination occurs at the time the versions are to be played; and the presentation controller directs the versions for a particular scene on receipt of a scene signal.

Each version may contain content for a scene in a different language.

The presentation controller may direct the version of a next scene on a list of scenes upon receipt of the scene signal.

The presentation controller may direct the versions of a particular scene indicated by the scene signal upon receipt of the scene signal.

In other aspects the invention provides methods by which the various other aspects may be utilized.

### BRIEF DESCRIPTION OF THE DRAWINGS

For a better understanding of the present invention and to show more were clearly how it may be carried into effect, reference will now be made, by way of example, to the accompanying drawings which show the preferred embodiment of the present invention and in which:

FIG. 1 is a schematic representation of the general purpose of the preferred embodiment of the invention,

FIG. 2 is a block diagram of scenes in a tour presentation used by the preferred embodiment of the invention,

FIG. 3 is a block diagram of versions of a scene of FIG. 2,

FIG. 4 is a block diagram of pieces in a music presentation used by the preferred embodiment of the invention,

FIG. 5 is a block diagram of categories for the pieces of FIG. 4,

FIG. 6 is a schematic representation of a presentation system according to the preferred embodiment of the invention,

FIG. 7 is a schematic diagram of scenes/versions of FIGS. 2 and 3 stored in digital presentation blocks,

FIG. 8 is a schematic diagram of pieces/categories of FIGS. 4 and 5 stored in digital presentation blocks,

FIG. 9 is a schematic diagram of play lists and play list items used in the presentation system of FIG. 6 in a tour configuration,

FIG. 10 is a schematic diagram of play lists and play list items used in the presentation system of FIG. 6 in a music configuration,

FIG. 11 is a schematic diagram of a play list item used in the play lists of FIG. 10,

FIG. 12 is a schematic diagram of channels in a play back system of the presentation system of FIG. 6,

FIG. 13 is a schematic diagram of pools of play list items and device definitions used in a presentation controller in the presentation system of FIG. 6,

FIG. 14 is a schematic diagram of a preferred embodiment of a wireless presentation system,

FIG. 15 is a schematic diagram of a wireless transmission portion of a playback system employed in the presentation system of FIG. 14,

FIG. 16 is a schematic diagram of a wireless receiver portion of a playback system employed in the presentation system of FIG. 14,

FIG. 17 is a block diagram of components of the presentation controller in the presentation system of FIG. 6,

FIG. 18 is a schematic representation of block to device logic employed in the presentation system of FIG. 6,

FIG. 19 is a graphical representation of a computer employed in the presentation system of FIG. 19,

FIG. 20 is a schematic representation of components of the computer of FIG. 19,

FIG. 21 is a schematic representation of a presentation controller application employed in the presentation system of FIG. 6,

FIG. 22 is a block diagram of a framework component and sub-components employed in the presentation controller application of FIG. 21,

FIG. 23 is a schematic representation of a configuration manager of FIG. 22 and data,

FIG. 24 is a schematic representation of a play list manager of FIG. 22 and data,

FIG. 25 is a schematic representation of a content manager of FIG. 22 and data,

FIG. 26 is a schematic representation of a device manager of FIG. 22,

FIG. 27 is a schematic representation of a statistics manager of FIG. 22,

FIG. 28 is a schematic representation of a security manager of FIG. 22,

FIG. 29 is a flow diagram of initialization of the presentation controller of FIG. 6,

FIG. 30 is a flow diagram of loading of streams into devices by the presentation controller of FIG. 6,

FIG. 31 is a flow diagram of controlling devices by the presentation controller of FIG. 6,

FIG. 32 is a flow diagram of a statistics process employed in the presentation controller of FIG. 6,

FIG. 33 is a flow diagram of a streaming process employed in the presentation controller of FIG. 6,

FIG. 34 is a flow diagram of an authentication process employed in the presentation controller of FIG. 6,

FIG. 35 is a further detailed schematic representation of the presentation system of FIG. 6,

FIG. 36 is a schematic representation of blocks to channel logic employed in the presentation controller of FIG. 6,

FIG. 37 is a schematic representation of a flow of blocks in a context type presentation configuration of the presentation controller of FIG. 6,

FIG. 38 is a schematic representation of a revised flow of blocks in a context type presentation configuration of the presentation controller of FIG. 6,

FIG. 39 is a schematic representation of context hash example employed in a context type presentation configuration of the presentation controller of FIG. 6,

### DETAILED DESCRIPTION OF THE PREFERRED EMBODIMENT

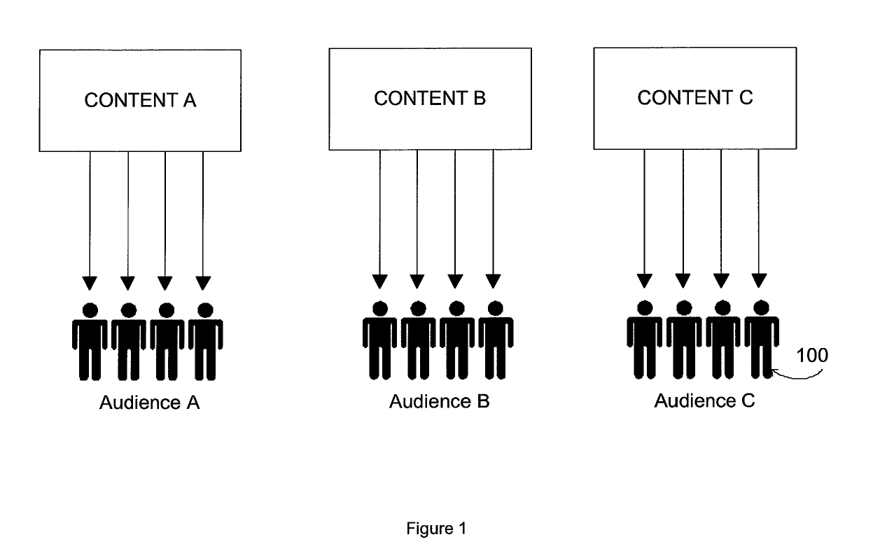

Referring to FIG. 1, the basic purpose is to deliver different content (Content A, Content B, Content C) to multiple audiences (Audience A, Audience B, Audience C) made up of audience members, for example, 100.

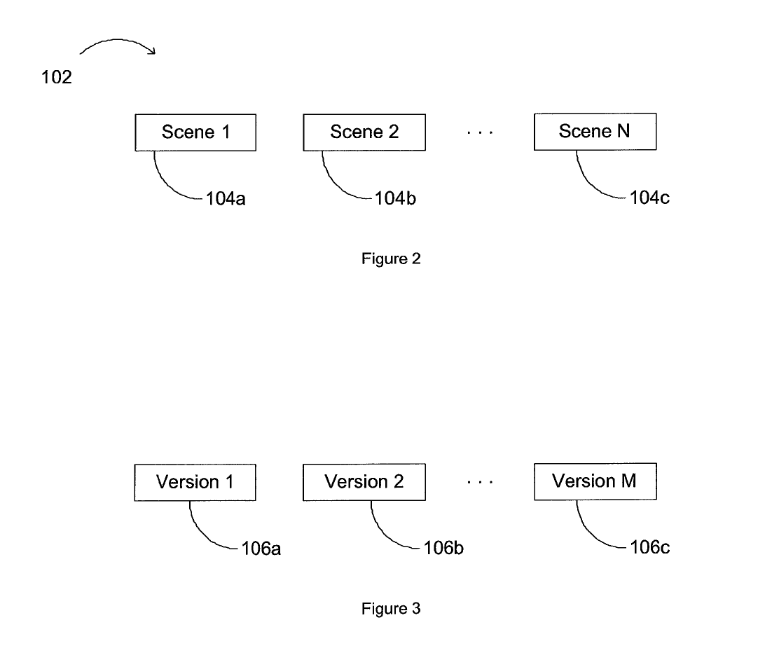

Referring to FIG. 2, the content may be arranged in digital presentation blocks 102. These are blocks of digital audiovisual content data in presentation form that are for presentation to an audience. The blocks may be located in digital files, databases or some other location, such as a URL. The content is not in process content, as might be used in a recording environment for separate tracks that might later be used to derive presentation content.

For a tour, each digital presentation block could be a scene 104a, 104b, or 104c with a narrative about a particular setting. For example, a scene 104a could be a narrative about the Empire State Building, while another scene 104b could be a narrative about Rockefeller Center, while yet scene 104c another is a narrative about the Statue of Liberty. Separate scenes could refer to individual details of a particular setting, the detail for each scene being its own setting, for example, separate scenes may describe in general a painting at a museum, while a separate scene might describe a particular detail of the painting. Alternatively, all aspects of the painting could be described in a single scene. A setting could be a particular location or it could be a time, or it could be a time and location, for example, the Statue of Liberty at sunset.

If video scenes are used then one scene might include video content that is appropriate for a particular setting, for example, a video scene of the construction of the Statue of Liberty could be played when audience members are passing the Statue.

Referring to FIG. 3, each scene 104 may have a number of different versions 106a, 106b or 106c. For example, each version 106 could be the scene 104 in a different language. In this case, where audio and video portions of a scene 104 are separate then there may be only one version 1061 of the video portion while there is a separate version 106b, 106c of the audio portion for each language. Alternatively, if desired there could be different video or audio/video versions for different languages. This might be particularly appropriate for playing advertisements, where different content may be targeted to different language groups.

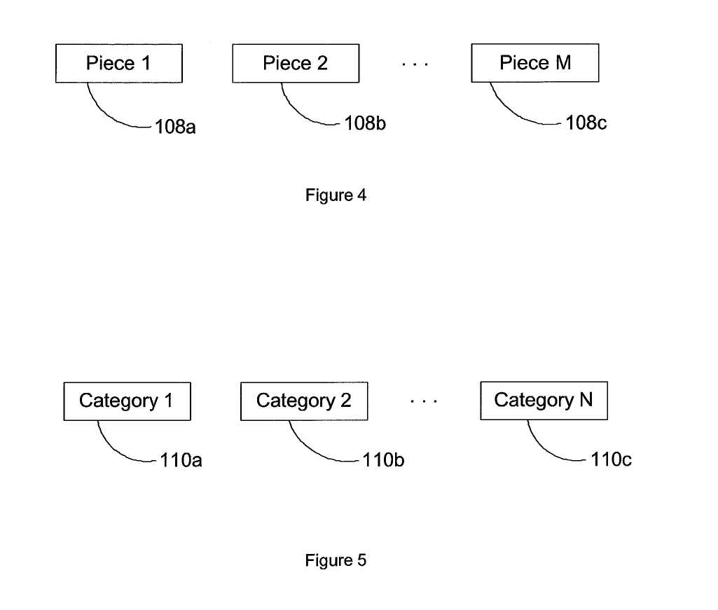

Referring to FIG. 4, alternatively, each digital presentation block could be a piece 108a, 108b, or 108c, for example a song. Referring to FIG. 5, the pieces 108 may fall into categories 110a, 110b or 110c, such as rhythm and blues, jazz, classical or soft rock, or such as different artists Elvis Presley, Mariah Carey, or Celine Dion. The division of categories 110 and pieces 108 may be entirely arbitrary depending on the available blocks 102 and audience A, B, C, D desires.

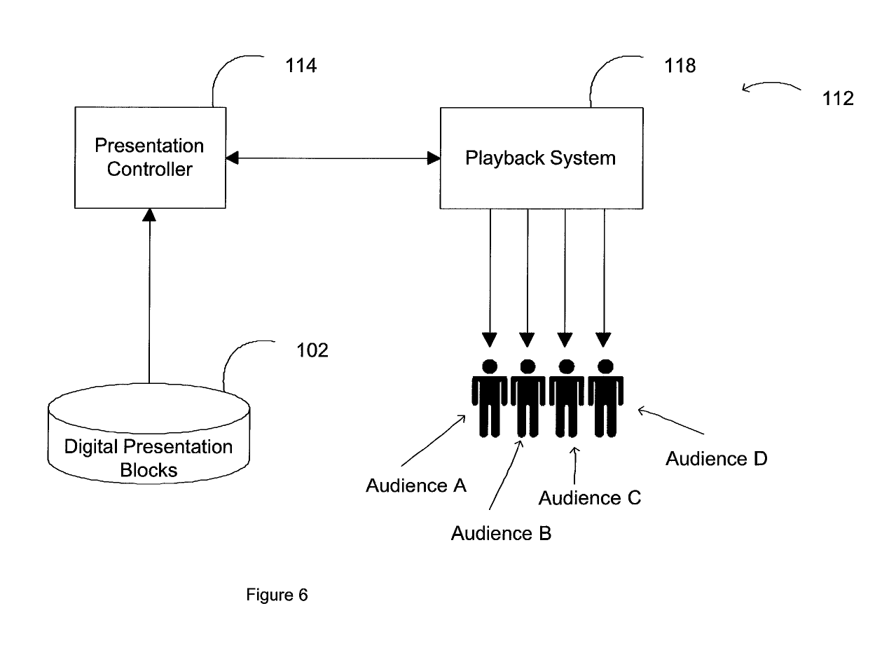

Referring to FIG. 6, a presentation system 112 has a presentation controller 114, digital presentation blocks 102, and a playback system 118. The presentation controller 114 controls what content (blocks 102) is to be played by the playback system 118.

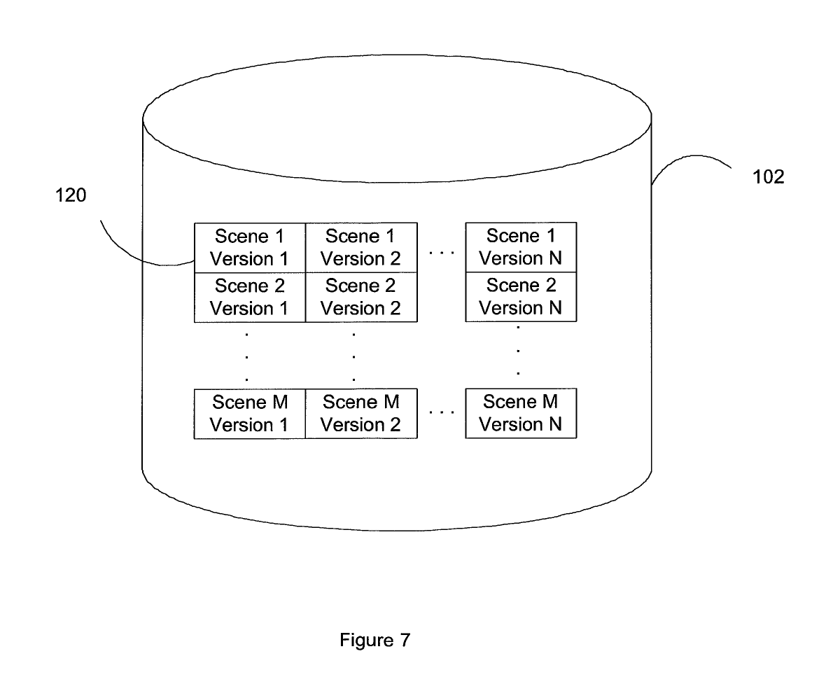

As shown in FIG. 7, the digital presentation blocks 102 may be stored as scene/versions, such as scene 1/version 1 120. Although the digital content 102 appears to be stored in a sequential matrix format, the Figure is only presented in this manner for ease of reference. As will be later described, the scenes and versions do not have to be arranged in this manner.

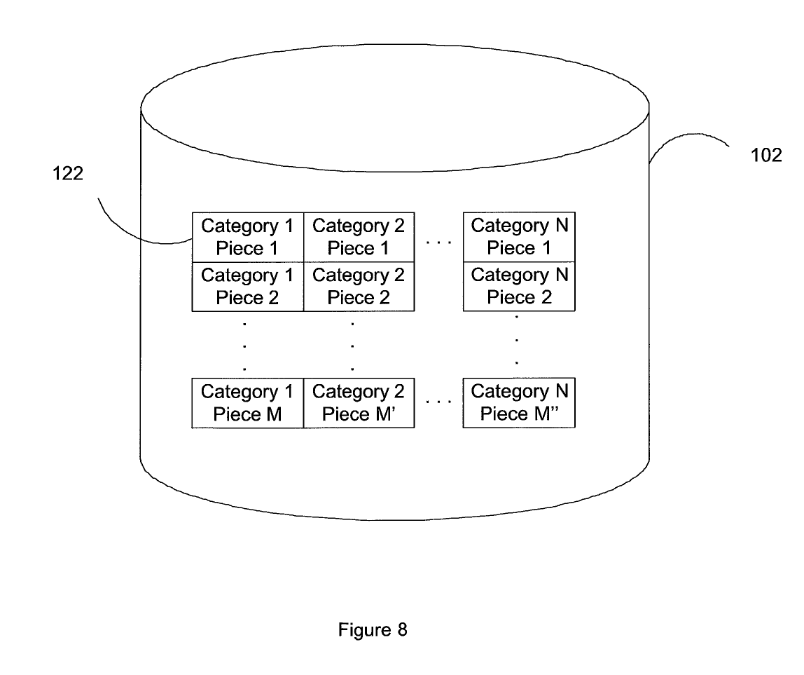

As shown in FIG. 8, the digital presentation blocks 102 may be stored as pieces/categories, such as piece 1/category 1 122.

Referring again to FIG. 6, the presentation controller 114 presents sets of scenes in multiple versions from the digital presentation blocks 102 to the playback system 118, and the playback system 118 plays the versions to the audiences A, B, C, D.

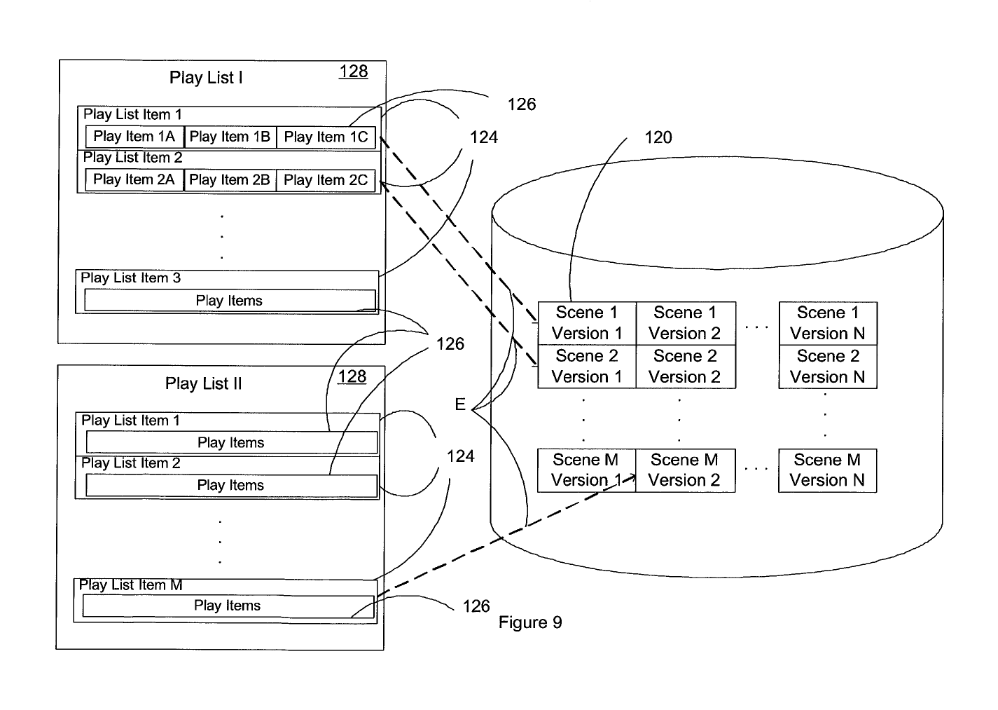

Referring to FIG. 9, the preferred embodiment of the presentation controller 114 uses play list items 124. Each play list item 124 references one or more play items 126. For the scene/version configuration each play list item 124 references play items 126 that in turn specify (examples represented by arrows “E”) a digital presentation block that contains a particular version of a scene, for example scene/version 120. Play list items 126 are organized into play lists 128; each play list 128 represents the scenes that make up a particular presentation. As will be described later, the play lists 128 may include the anticipated order in which the play list items 124 are to be played. Alternatively, play list items 124 may be referenced individually at the time the play list item 124 is to be played in accordance with the particular audience setting.

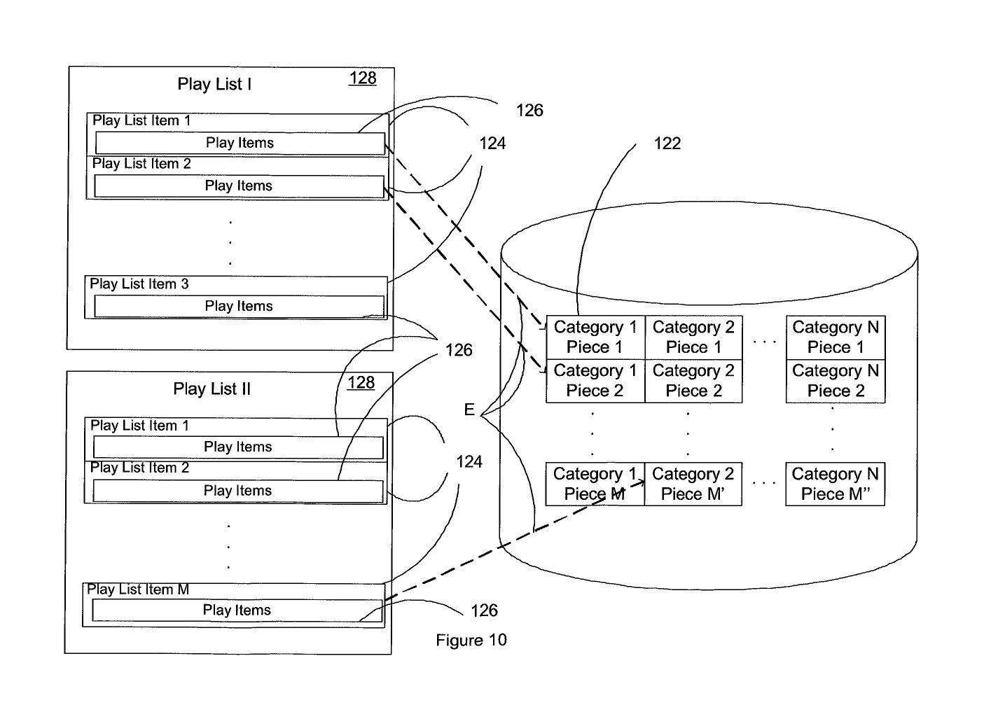

Referring to FIG. 10, similarly, for the piece/category configuration each play list item 124 references play items 126 that point to a digital presentation block that contains a particular piece, for example piece/category 122. Again, the piece 122 may or may not have a category.

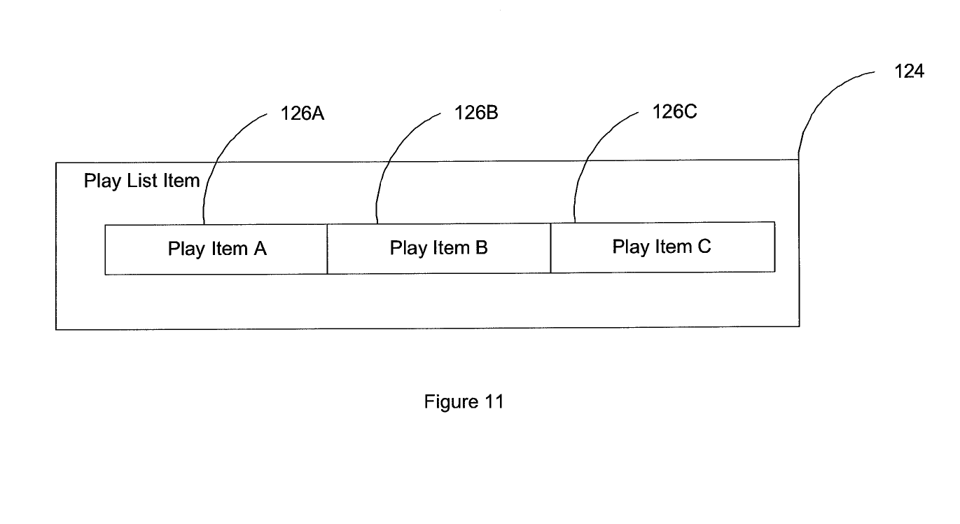

Referring to FIG. 11, as mentioned previously, play list items 124 can reference more than one play item, for example play items 126A, 126B, 126C. In the preferred embodiment related to tours it has been found to be particular effective to have a play list item reference 124 three play items 126A, 126B, 126C; a header 126A, for example, referencing a digital presentation file with a brief advertisement, a content portion 126B referencing a digital presentation file with the applicable narrative, and a trailer 126C, for example, referencing a digital presentation file with music filler.

Play lists 128 fall into two general types; sequence and context. In the simplest form of a sequence type, play list items 124 are simply played one after another without synchronization with a play list item 124 for another audience A, B, C, D. This form would be most appropriate for the piece/category configuration, where one piece plays right after the last piece to a particular audience. For a contextual type certain play items 124 are meant to be played at the same time as other related play items 124. For example, in a tour a scene (eg. narrative of the Eiffel Tower) is meant to be presented in all versions (in this case, languages) simultaneously (i.e. at the time that the Eiffel Tower is being viewed on the tour) to all audiences A, B, C, D. There may be delays between the playing of some play list items 124 for one audience, for example A, until an appropriate context (such as a scene signal from an operator or an external source) indicates that the play list items 124 should be played. Such delays may present an opportunity for other play items 126, such as advertisements or music to be played. A context type play list 128 may be thought of as a sub-type of a sequence play list 128 as it is a sequence play list 128 with additional restrictions.

Sequence play list items 124 are stored in sequence play lists 128. Context play list items 124 are stored in context play lists 128.

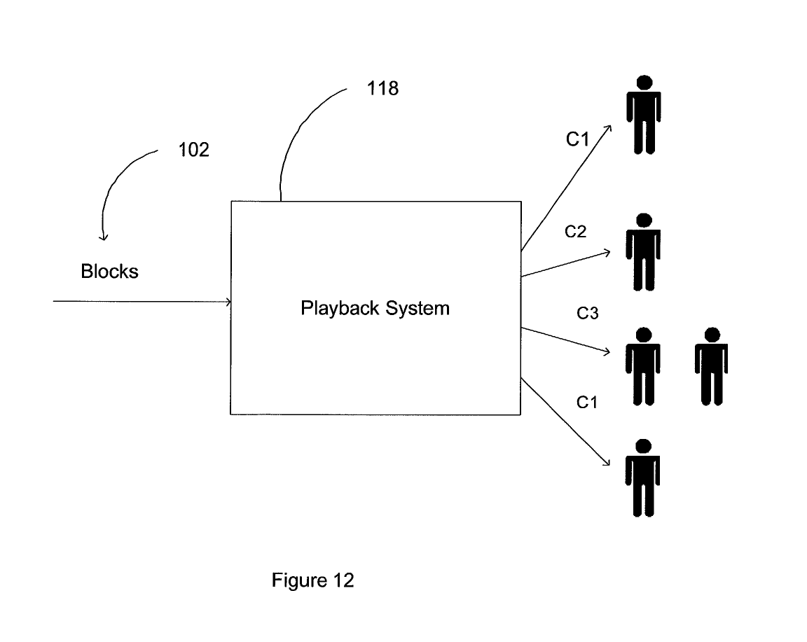

Referring to FIG. 12, the presentation controller 114 plays the digital presentation content 102 to addressable channels C1, C2, C3 of the playback system 118. For the scene/version configuration, the content 102 represents different versions of a particular scene as specified by a play item 126 in a play list item 124 on a play list 128; while, for the piece/category configuration, the content represents different pieces, perhaps from different categories, as specified by a play item 126 in a play list item 124 on a play list 128. The playback system 118 then provides the content 102 to the addressed channels, for example C1, C2, and C3, which may be selected by, and heard by, one or more audience A, B, C, D.

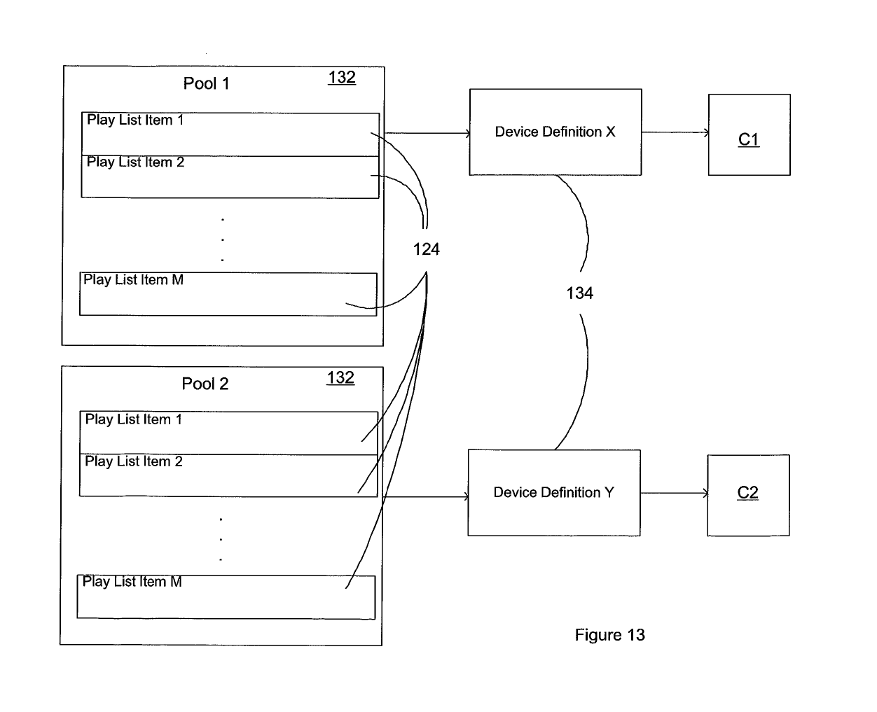

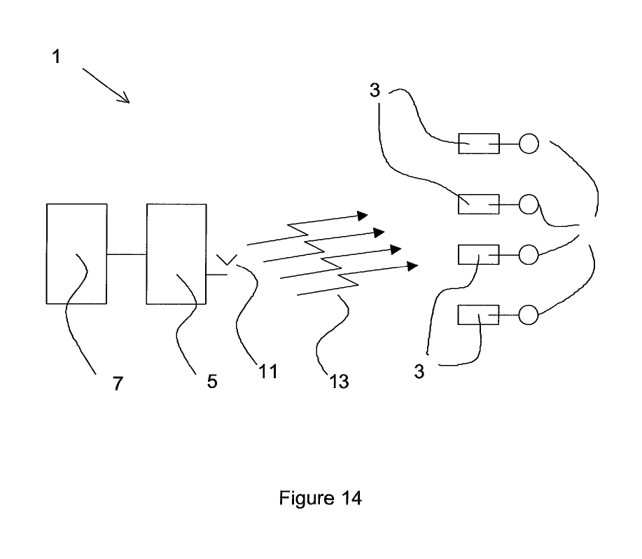

Referring to FIG. 13, for ease of management, the presentation controller 114 organizes play list items 124 into play list item pools 132. A pool 132 represents play list items 124 that may be assigned to a channel or group of channels, for example C1 or C2.

In the preferred embodiment, the presentation controller 114 utilizes device definitions 134 that define one or more channels, such as C1, C2 to which play list items 124 are to be played. In the preferred embodiment, the device definition 134 indirectly references the play list items 124 by referencing the pool 132 to which a play list item 124 has been assigned.

Referring to FIG. 14, a wireless presentation system 1 extends the benefit of a tour presentation to a visitor by providing the visitor with a stored presentation in multiple languages. A visitor wears a portable radio receiver 3 that receives a transmission from all language broadcast channels and selects which of the channels to listen. The stored information is arranged as digital files that can be called and sent to a transmitter 5 for broadcast. Each digital file contains the tour presentation in a specific language. A computer 7 is programmed to track the tour path or events and broadcasts the information for a given or specific site at the command of a tour operator or automatically when receiving external information such as a GPS signal or switch signal indicating that it is ready to transmit the information about that specific site. The computer program within the computer 7 selects files containing the site information in multiple languages and the system 1 broadcasts the information in the files over individual radio channels.

The system 1 uses stored presentations recorded and digitized for use by a computer 7. The computer program calls selected languages describing the site or event at a time that is synchronized with the actual site or event, such as a tour boat passing the Statue of Liberty 8. The multiple language files are output to a de-multiplexer, included in FIG. 1 as part of the transmitter 5, that separates each language into an individual channel for broadcast over a wireless transmitter 5. The visitor receives the information via a wireless receiver 3, tuned to their language-channel, and listens to the presentation via a headset 9.

A computer 7 programmed to respond to switch, voice, external signals 13 for selection of specific information, pre-recorded and digitized into data files, that outputs the selected files to a wireless transmitter 5. The information from the data files may be transmitted via a multi-plexed digital format using such RF modulation technologies as spread-spectrum frequency hoping, time division multiple access, code division multiple access, standard analog channels using different forms of modulation such as frequency modulation, time-domain modulation or amplitude modulation. The wireless transmitter 5 feeds one or multiple antennas 11 covering the area or desired range. The antenna 11 may also consist of high-loss coax, ground-plane, vertical or horizontal dipoles, or other wireless signal broadcast technologies. The wireless receiver 3 contains circuits necessary to receive transmitted signals 13 and to de-modulate the signal into audio information that is amplified and output to headset 9. Contained in the receiver 3 is a selector device adapted for selecting the desired channel and thereby the desired language.

As discussed previously, the system 1 delivers simultaneous channels of sound to a listening audience of one or more individuals (visitors). Each individual will receive an audio signal through listening equipment (typically headphones 9) The audio signal may be, but is not restricted to, a commentary that is in the language of the listener.

The presentation system 1 used for the preferred embodiment will be described with application to the tourism industry, although it may be used in other listening applications, such as venues that feed audio data to multiple locations within the physical environment, for example libraries, museums and outdoors, entertainment establishments such as bars and restaurants that operate based upon a theme (pre programmed content—music or commentary or advertisements). Auditoriums, class-rooms, places-of-worship, courtrooms, guided and un-guided tours such as boats, buses, and walking tours whereby the user can listen to a portable radio tuned to a channel covering the language of choice, and transportation industry applications would also be appropriate.

As is evident from the above description of FIG. 14, the presentation controller application to be described herein may be used for the computer program in computer 7.

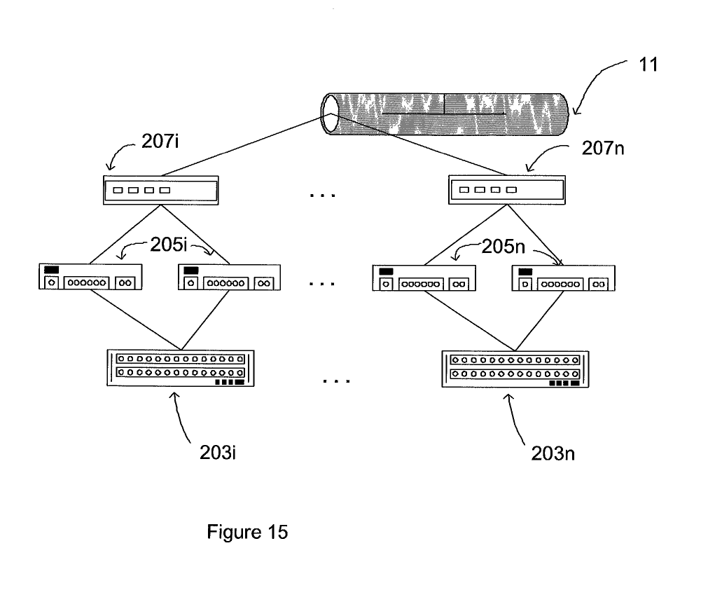

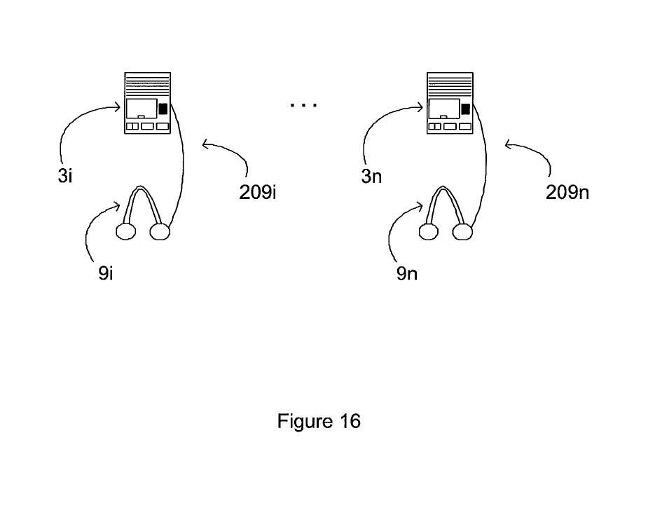

Referring to FIGS. 15 and 16, the playback system 118 of a preferred embodiment has a number of devices 203 that receive the streams from the presentation controller 114. Audio devices 203 may, for example, be two channel sound cards located within computer 7. As the playback system 118 of the preferred embodiment for a tour is a wireless system, output of the audio devices 203 may be put through a transmitter 205 and a combiner 207 that transmit a signal over antenna 11 for reception by a receiver 3. The receiver 3 is tuned to a desired channel for reception of a particular version of a scene and for presentation to an audience member through user presentation equipment, such as headphones 9. In the case of an audio presentation, the equipment 9 could be a wand (shaped similar to a telephone), an earpiece, or a speaker if it is isolated from other speakers (such as at a private table in a restaurant in a manner similar to a limited area jukebox). Alternatively, the devices 203 could be external to the computer 7; for example, a Midiman Delta 1010 might be a suitable device 203 to receive equivalent data from the computer 7 that a sound card would be provided. The actual format of the data will in part be determined by the requirements of the device 203 as specified by the device manufacturer.

Typically audio devices 203 have more than one, but not an unlimited number of, channels. Stereo sound “cards” typically have two channels, left and right; however, devices with less or more channels are available and may be used. Such cards may be packaged in up to four or more “cards” on a single computer board. For the purposes of this description, each sound card would be considered to be a separate device 203 even where multiple cards appear on a single board. The cards must allow external addressing of its output channels by the presentation controller 114.

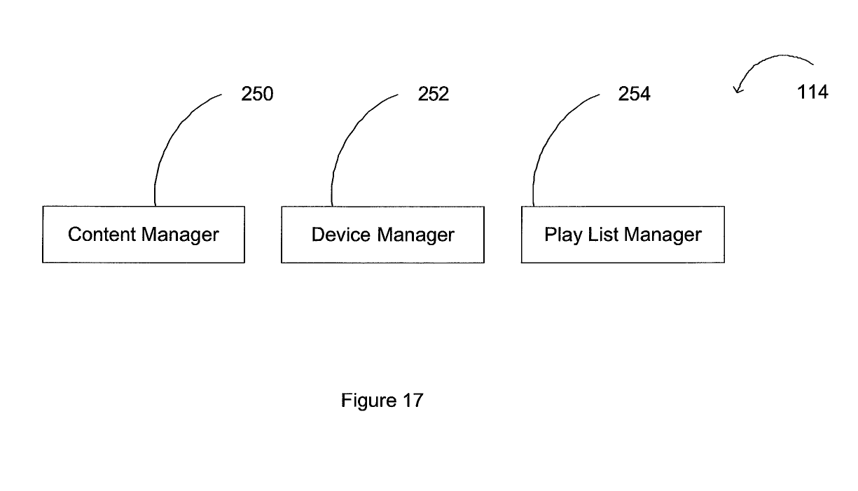

Referring to FIG. 17, in a preferred embodiment the presentation controller 114 has a content manager 250, a device manager 252 and a play list manager 254. The play list manager 254 determines the play items 126 that are to be in a play list 128. The content manager 250 creates data streams of content from the data block 102 in accordance with the play list 128. The device manager 252 keeps track of the status of devices 203, and assigns streams from the content manager 250 to channels of devices 203.

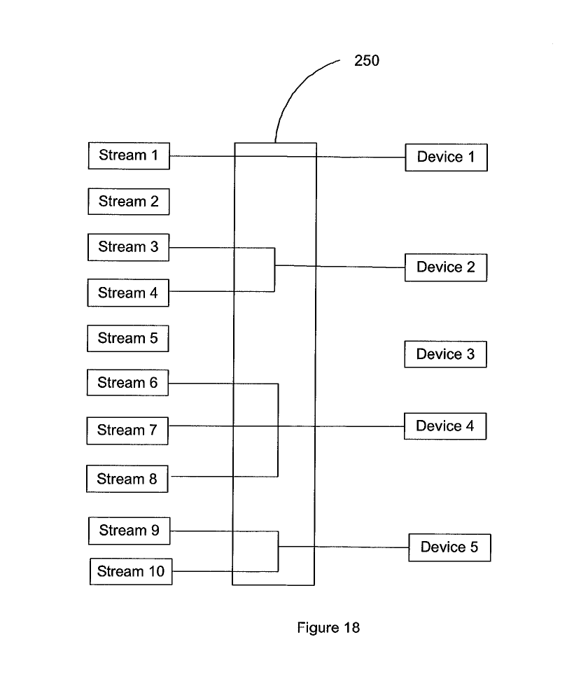

Referring to FIG. 18, audio devices 203 within a presentation system 112 may change from time to time. For example, devices 203 may be added for increased capacity, or a channel in a particular device 203 may become unusable. This can be accounted for, for example, by replacing the device 203 with a similar device 203, reconfiguring the digital content 102 to play on different devices 203, or not using the full capacity of all devices 203.

In the preferred embodiment of presentation system 112, a better solution has been employed. For maximum flexibility, each digital presentation block 102 contains content for a play item 126 for a single version of a scene, such as scene/version 120. To the extent scene/versions (for example 120 within another scene/version) are required to be mixed for playing on a particular device 203, the scene/versions are combined if, and when, required at the time of playback by the presentation system 112. For example, device 1 is a single channel device 203 and stream 1 is not combined with any other stream, devices 2 and 5 are dual channel devices 203 therefore stream 3 is combined with stream 4 and stream 9 is combined with stream 10, device 3 is not used, and device 4 is a three channel device and stream 5 is combined with stream 6 and stream 7. Streams 2 and 5 are not used. The combination is performed by the content manager 250 of FIG. 17.

The preferred embodiment will now be described in some aspects with respect to the use of objects and object oriented programming techniques. As will be evident to those skilled in the programming art, custom classes and objects may provide some benefits in terms of programming and maintenance. However, implementations are not limited to object oriented programming and custom classes and objects, traditional (procedural) or other programming techniques can be used. For example, objects may alternatively be represented as individual data records and related programming functions or subroutines, and such records, functions and subroutines are encompassed within the principles described herein. With respect to the detailed preferred embodiment, an object may have attributes (data) and behaviour (methods). Relating this to procedural programming, the attributes could be replaced by variables, and the methods could be replaced by functions or subroutines. The variables, functions and subroutines replace the object itself.

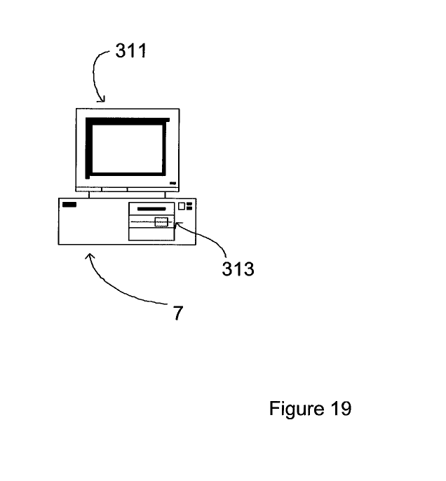

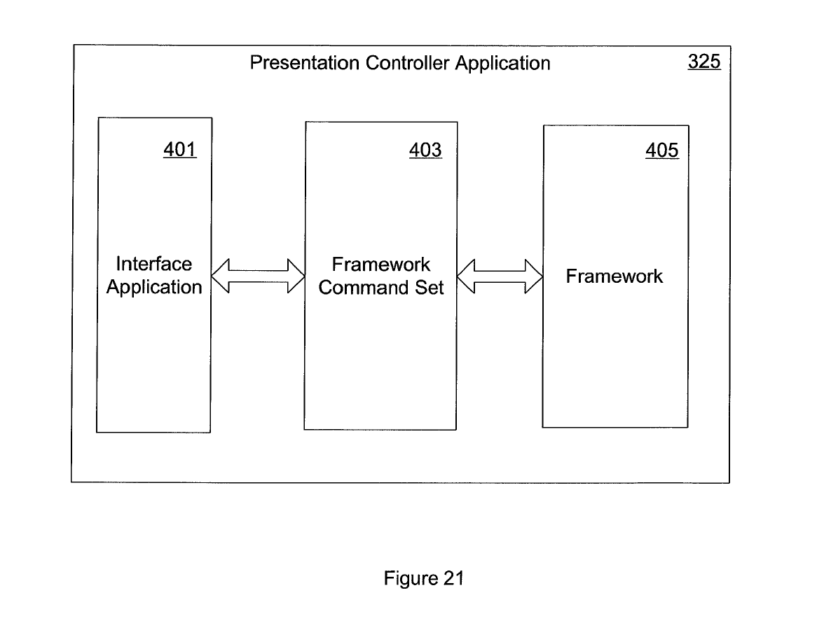

Referring to FIG. 19, the presentation controller 114 may be further embodied in hardware and software. A computer 7, which can be a personal computer, runs software, that will later be described more fully with respect to FIGS. 21 and forward as presentation controller application 325. The presentation controller application 325 is capable of communicating through the computer 7 with an audio device 203 having separate channels that have digitized information fed to them independently. Referring again to FIG. 15, in wireless embodiments, each channel of the audio device 203 is connected to a transmitter 205. In the present version of the preferred embodiment, each transmitter 205 takes one analog signal from one device 203, applies filters on the signal and passes it on to a combiner 207. As the present version uses only 2 channel devices 203, the signal is a two channel signal. In other embodiments, the devices 203 may have alternate numbers of channels as described previously. The combiner 207 sums the signal from the device 203 with other signals from other devices 203 that arrive from other transmitters 205 and places the combined signals onto an antenna 11. The preferred embodiment would work equally well with a signal transmitter 205 that receives all of the streams from the devices 203 and outputs a single signal for placement on the antenna 11.

In the preferred embodiment of the system 1, each channel of sound is transmitted at a unique frequency. No two channels are assigned the same frequency. The antenna 11 has multiple signals each assigned to a unique frequency, represented by signals 13. As mentioned previously, other wireless broadcast technologies could be used. As will be known to those skilled in the art, some wireless broadcast technologies involve the use of different frequencies; however, other channel division means, such as time splicing could be used. “Channel” in each case is a means of transmitting a stream of information that an audience member 100 can select for listening using a receiver 3.

The receiver 3 is worn on the body of the audience member 100 and is connected by cable 209 to a pair of headphones 9. The receiver 3 may be tuned by the audience member 100 to receive one signal from the antenna 11. In other wireless broadcast technologies, the receiver 3 may fixed to a single signal that contains all channels of information, and circuitry, possibly including programmable memory, within the receiver 3 to permit the audience member 100 to hear a selected channel.

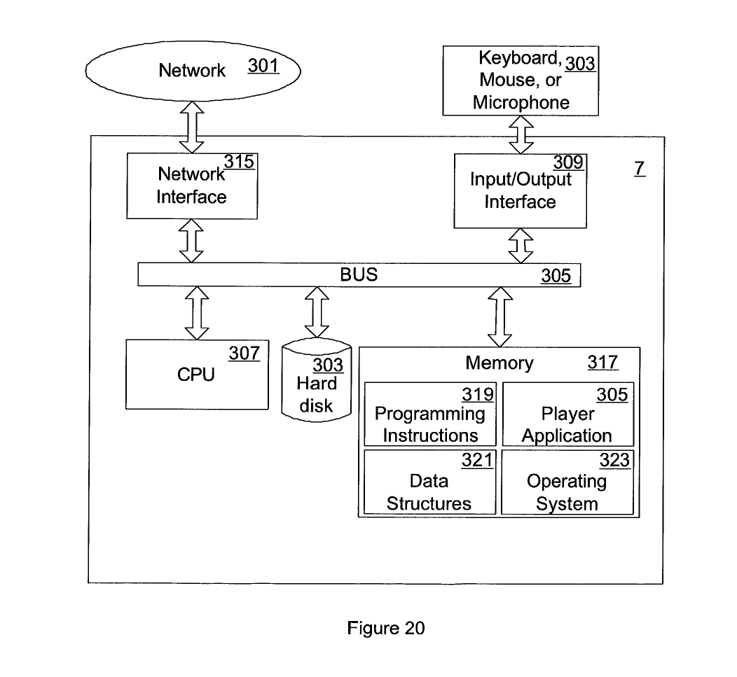

Referring to FIG. 20, an embodiment of computer 7 may be on a network 301 and have as input devices a keyboard, mouse, or microphone 303. It is internally connected to a bus 305 that interconnects various subsystems or components of the computer 7.

A CPU 307 is a commercially available central processing unit suitable for the operations described herein.

An input/output interface 309 enables communication between various subsystems of the computer 7 and various I/O devices, such as keyboard, mouse, or microphone 303. The microphone can be used for voice activation. I/O interface 309 includes a video card for operational interfacing with a display unit 311 (in FIG. 19) and a disk drive unit for reading computer-readable media, such as a floppy disk, or CD 313 (in FIG. 19).

A network interface 315 in combination with communication software, such software being well known and readily available, enables communication with other computers connected via the network 301. Optionally the network interface 315 may also enable remote control of the computer 7.

Memory 317 includes both volatile and persistent memory for storage of programming instructions 319, data structures 321, operating system 323, and the presentation controller application 325.

The operating system 323 cooperates with the CPU 307 to enable various operational interfacing with other components of the computer 7.

The computer 7 also contains a hard disk 327 suitable for non-volatile storage of files, such as operating system files, application files, and audio media.

It will be evident to those skilled in the art that the embodiment described for computer 7 is only one of many possible embodiments that may be employed to provide computing means for carrying out the features and functions described herein.

Referring to FIG. 21, the preferred embodiment of the presentation controller application 325 is built on three major components, including interface application 401, framework command set 403, and framework 405:

Interface Application 401—This can be represented by any application that has graphical user interface, or command line interface. Software development kits to assist in the implementation of an interface application may, for example, include Microsoft MFC control classes, Microsoft SDK, OS/2 Presentation Manager, UNIX Motif, or Macintosh SDK. The presentation controller application [this is one of many possible applications] 325 is not dependent upon any specific implementation of controls as framework command set 403 defines the conceptual boundary between the front end 401 and framework 405. An interface application using the framework will communicate with the framework via a command set. The framework interface that the interface application uses is very simple, i.e. ProcessCommand method. The interface application must construct a command (e.g. Play) and submit this command to the framework's ProcessCommand method (or function). The separation of the interface application from the other major components permits the interface application to be easily run on a separate computer for remote operation of this aspect of the presentation controller. It also permits the interface application to be easily incorporated into a larger application, not shown, with other purposes.

Framework Command Set 403—This command set 403 defines how the interface application communicates with the Framework. The command set 403 hides the sub-components of the framework 405. The framework 405 publishes (makes available) the framework 405 sub-components to each command in the command set 403, and the command set 403 does not expose the framework 405 sub-components to the interface application. 401.

Framework 405—The framework 405 may contain a number of framework 405 subcomponents that contain instructions for performing the tasks described herein.

The Framework itself is very simple. Essentially it executes Framework commands. Prior to each command execution it can determine whether the command should be executed (a security feature) and whether framework subcomponents are in a state that may allow the command to execute properly (for example, are the subcomponents initialized). In the preferred embodiment an interface application 401 using the framework 405 and framework command set 403 cannot execute the command directly. This can be important feature. The framework 405 is essentially a command interface to framework subcomponents.

In the preferred embodiment, the framework 405 object does not have attributes that represent the subcomponents of the framework 405. The subcomponents exist independently as singleton (single instance only) objects. This is desirable because more framework 405 subcomponents can be added at a later date without having to change the framework command set 403 and already existing framework commands.

It is not necessary to split the presentation controller application into the three main components 401, 403, 405; however, it does provide additional features and functionality, including security and simplicity for different users of the presentation system.

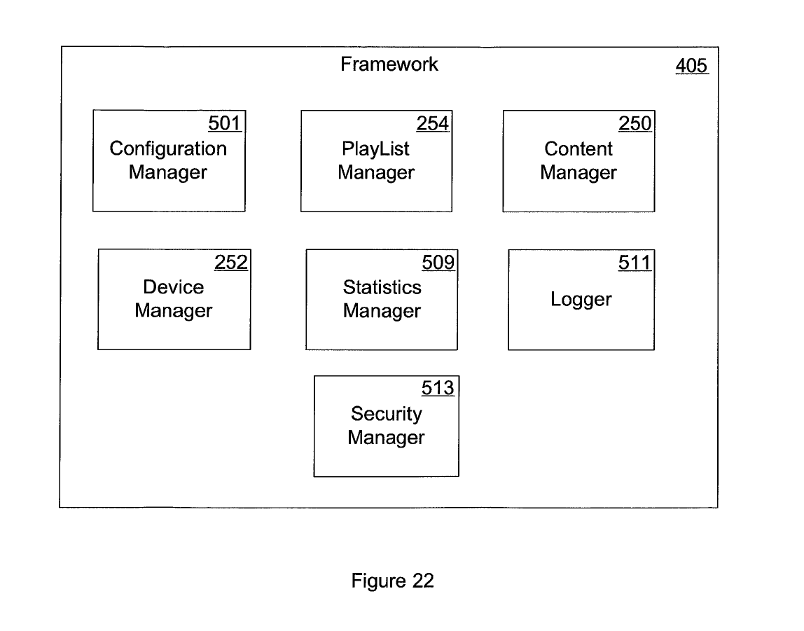

Referring to FIG. 22, framework 405 is built on preferred embodiments of three previously introduced managers, and other sub-components, namely:

Configuration Manager 501—This component 501 is responsible for building a configuration object 603 to more fully be described with respect to FIG. 17. The configuration object 603 describes the initialization data and configuration data required for the operation of the framework 405 and other subcomponents. It 603 is also capable of storing any specific data that the front end graphical user interface 401 may need to initialize controls, views, etc.

The configuration object 603 may be represented in a physical format such as an XML file 605, or rows in a database 607. The configuration manager 501 has the ability to build a configuration object 603 from any source without the configuration object 603 knowing how it was built.

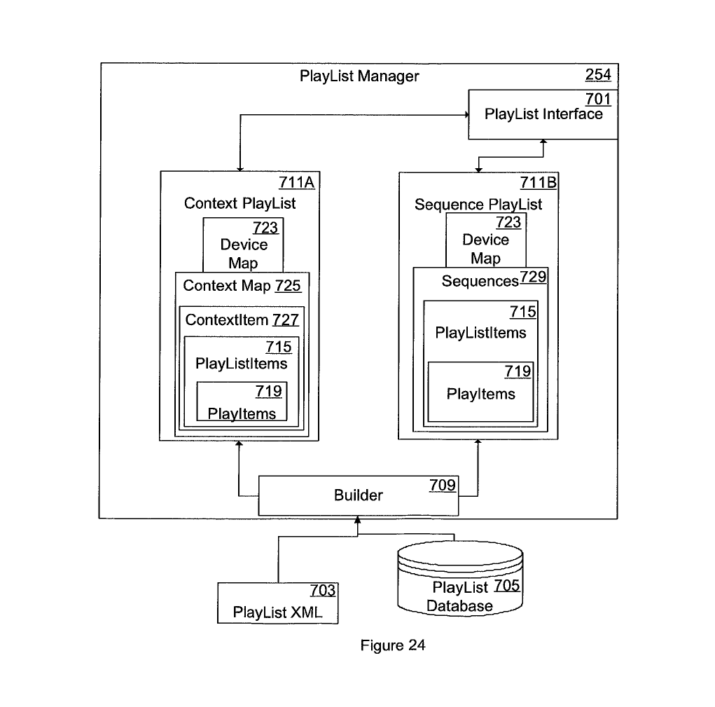

PlayList Manager 254—This component 254 is responsible for building, validating, and providing a means of navigating through PlayList objects 715 to more fully be described with respect to FIG. 24.

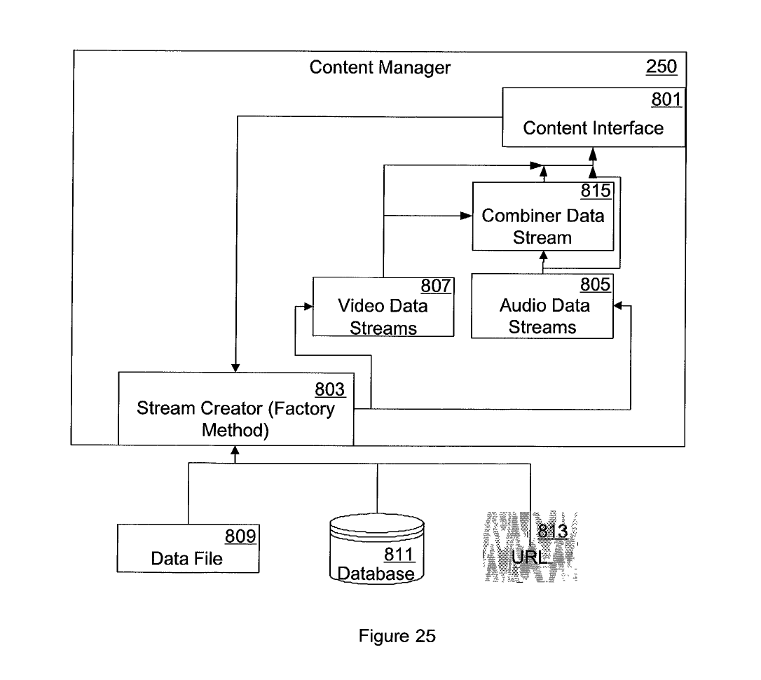

Content Manager 250—This component 250 creates in -memory data streams 805, 807, 815 (to more fully be described with respect to FIG. 25) of audio or video data and bundles up the streams into one object that is to be handled by device manager 252. The source of data is validated at this point. That is to say that the source is validated for its existence, and then its content.

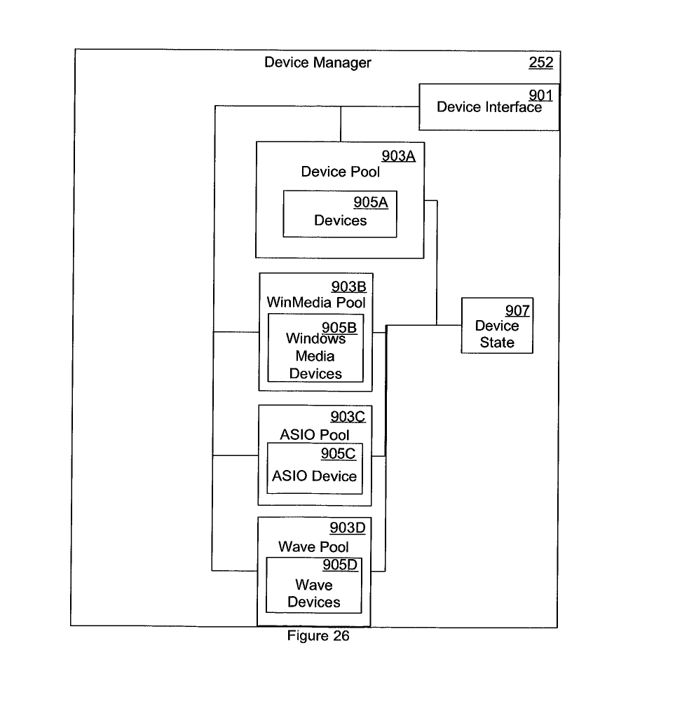

Device Manager 252—This component 507 manages pools 903 of device objects 905. As will more fully be described with reference to FIG. 26, a device pool 903 contains a set of device objects 905 that have a common interface. Device objects 905 reflect, among other things, the properties that a device 203 may have and actions that a device 203 can be caused to take. For example, devices 203 that are controlled by calls to the Windows Wave APIs will exist in one pool 903D, where as devices 203 controlled by ASIO APIs exist in another pool 903C. A device object 905 is located within the pool 903 by its device name.

When initializing a device 203 with a stream, the stream originates from the content manager 250. Thereafter, the device 203 may be controlled (for example, play, pause, stop) through the device object 905 independently without interaction with other framework components. A stream may be assigned to one channel of the device object 905 if the stream content is mono. This can be considered one device 203 from the point of view of device map 723 depending on how the device driver works. One device 203 can be represented by device definitions 134 in the playlist 128 for each channel. For a stereo or split mono stream, the stream is assigned to both channels of the device 203. In this case, one device 203 can be represented by a single device definition 134 in the playlist 128 for that group of channels, and the device map 723 will consider the group of channels as a single device 203.

Statistics Manager 509—This component 509 builds and stores a statistics object that is capable of determining statistics that are to be logged by other components. The statistics object is built with the assistance of the configuration manager 501.

Any command from the framework command set 403 may register itself with the statistics manager 509. From the statistics manager 509 internal statistics object, the command may or may not be logged.

Logger 511—Logger 511 is a utility component that performs a logging action. Any framework 405 component has access to the logger 511.

Security Manager 513—This component 513 validates requests that may be performed only if security constraints have passed. The security manager 513 contains a number of objects that perform validation tasks based on a unique validation algorithm.

For example, to enter administrative functions of the presentation controller application 325, the security manager 513 is called upon to validate a password. Or, to start the presentation controller application 325, the security manager 513 is required to validate a hardware serial number against a license string provided to the user of the presentation controller application 325.

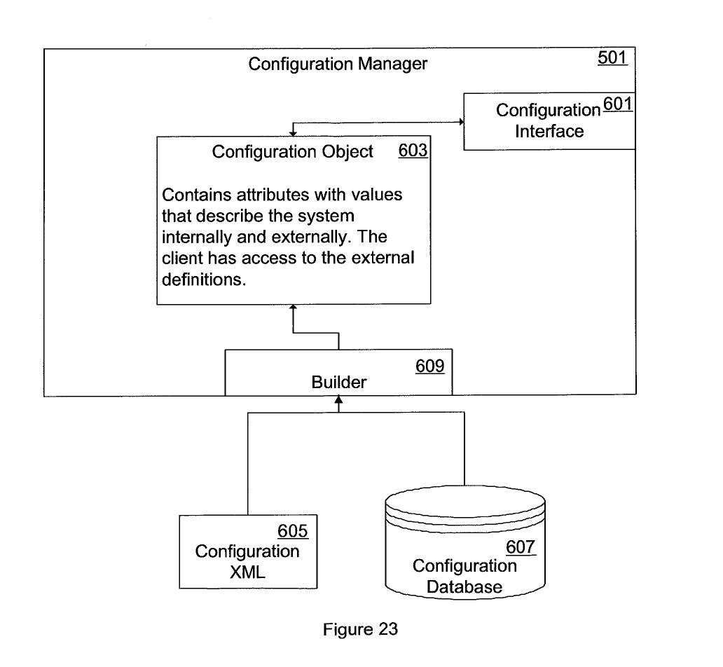

Referring to FIG. 23, the configuration manager 501 is the first component that the framework 405 initializes as it 501 is the component responsible for determining presentation controller 114 settings that other components need to initialize.

A configuration interface 601 of the configuration manager 501 allows the framework 405 to initialize the component 501, or obtain a read-only version of the configuration object 603 for any application 401 or framework 405 component to read from.

The source of the configuration object 603 may, for example, be an XML document 605, or rows from a table in a database 607. It is up to builder 609 to determine the source and build the configuration object 603 without the object 603 having any knowledge of its external representation. An example XML document 605 might contain the following:

<?xml version=“1.0” encoding=“iso-8859-1”?>
<!DOCTYPE config SYSTEM “config.dtd”><!-@version: -->
<config>

<client name=“XYZ Tour Company”/>
<playlists>

<playlistspec source=“c:ΔnewdaeΔconfigΔcontextplaylist1.xml”/>
<playlistspec source=“c:ΔnewdaeΔconfigΔcontextplaylist2.xml”/>
<playlistspec source=“c:ΔnewdaeΔconfigΔsequenceplaylist1.xml”/>
<playlistspec source=“c:ΔnewdaeΔconfigΔsequenceplaylist2.xml”/>

</playlists>
<dsp buffersize=“56000”/>
<logger filespec=“PlayerLogFile.txt”/>
<stats filespec=“statsfile.txt”/>

<ruleset name=“CheckSkips”/>

</stats>
<admin password=“ABCDEF0123456789ABCDEF0123456789” mode=“persist”/>

</config>

The configuration object 603 may contain the following information:

1. Identification of the customer using the presentation controller application 325 to display the proper logos and advertising information.

2. A list of playlist blocks for the playlist manager 503 to load upon system 1 startup.

3. Passwords for functional security and unauthorized usage.

4. Logging information such as log file and log level specifications.

5. Reference to the statistic rules that are defined in another source.

6. Any DSP information that is considered default should other components not define it at a more granular level (e.g. device buffer sizes.)

Once initialized, this component 501 is, for the most part, queried for the configuration object 603. It may also write to the configuration object if an administrator of the application using the framework is allowed to change system 1 settings through some user interface.

Referring to FIG. 24, the playlist manager 254 is responsible for building an in memory 317 image of a playlist 128 in playlist objects 711. The source of the playlists 128 may be, but is not restricted to, an XML file 703, or rows in a table managed by an RDBMS 705. The playlist 128 source will typically contain information that defines itself (a descriptive name for example), context definitions, logical device definitions, data file specifications, and DSP information.

Builder 709 component has knowledge of all supported formats. Depending on the format, a specific instance of builder 709 is instantiated and used to create one or more playlist objects 711.

There may be a number of playlist types that can be managed by the playlist manager 253. Each type is unique in the way that the playlist object 711 responds to navigation requests that arrive at the playlist interface 701. More playlist types can easily be supported in the framework 405 as new external representation and navigation requirements are specified. Additional playlist types might include further subsets of the sequence type. One example may be a dynamic sequence playlist 128 where the playlist 128 is initialized as being empty but constructs itself based on what the audience member 100 wants to hear or see. The presentation controller application 325 may initialize with nothing in the play list 128 set. The user then specifies what is to be played, and the order in which it is to be played. The playlist 128 is then built dynamically.

Such types can be incorporated into the play list manager 254, for example, by adding a new xml definition that dictates the rules of construction. The playlist 128 must have the same interface as other existing playlists 128 so that a framework command from the command set 403 can operate on the playlist 128 as it does on any playlist 128.

Each playlist object 711 manages one or more playlistitems 715. A playlistitem 715 can contain one or more playitems 719. A playitem 719 will contain a reference to a source of audio or video data, DSP data, and display information.

The composition of playitems 719 in playlistitems 715 offers flexibility in that the configuration of a playlist object 711 may specify audio or video segments that have a specific role that governs how and when the playback of the segment is performed.

Each playlist object 711 contains information as to which channels are to be assigned a collection of streams 715. This is done through device map object 723, which every playlist object 711 has defined. This offers flexibility in being able to dynamically assign audio or video content to different devices 203 at runtime. An example mapping table of a device map is:

Device Map

| Pool Key | Device Key | Device Definition in XML |
|---|---|---|
| P1 | D1 | Def1 |
| P2 | D2 | Def2 |
| P5 | D3 | Def3 |
| P7 | D4 | Def4 |

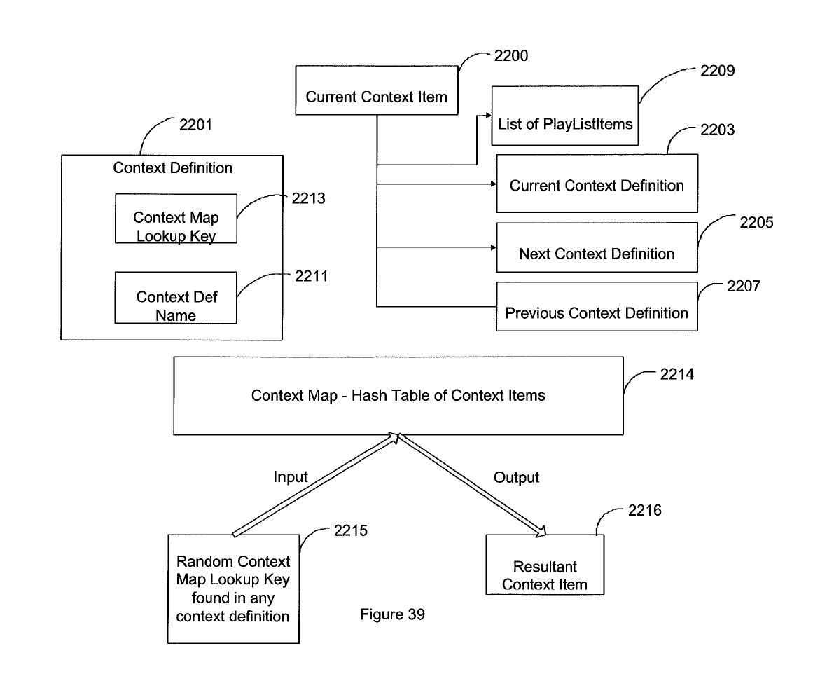

The context playlist 711A contains one context map 725. A context map 725 is a wrapper for a hash table and contains one or more context items 727. Each context items 727 contains one or more playlistitems 715. A context item 727 is located in the context map 725 of a context playlist 711A by its context key as will be later described in reference to FIG. 39.

The sequence playlist 711B contains one or more sequences 729. A sequence 729 contains one or more playlistitems 715. A playlistitem 715 is located in a sequence 729 by its known position in the sequence 729. For efficiency, a sequence 729 is a wrapper for a hash table of playlist items 715, each of which is located by the known position value in the sequence 729.

Referring to FIG. 25, the content manager 250 is primarily responsible for identifying the audio or video sources that are specified in the playitem objects 719 contained within a playlist object 715 and transforming them into data streams that may be properly interpreted by the devices 203 that receive the streams.

Content interface 801 is the means by which the framework command set 405 can communicate with this component 250. A collection of one or more playlistitems objects 715 is submitted with a request to produce logical data streams.

A playitem 719 derived from the playlistitem 715 is submitted to a stream creator 803, which applies a factory (default) method pattern to produce data streams. The source of the data can appear in a data file 809, a database 811, or from a networked computer, such as a URL 813. To support other physical formats and locations of data, only the stream creator 803 needs to be updated with other methods.

Once a stream object is created, it can be combined with other stream objects to produce a stream combiner 815. This allows streams to be combined at runtime to dynamically create one resultant stream that is assigned to one device 203.

A collection of data streams is returned to the interface 801 to be assigned to the devices 203 that are to play them. This assignment is the responsibility of the device manager 252.

Referring to FIG. 26, the device manager 252 is responsible for managing all audio or video devices 203 that are detected and requested for playback in the system 112.

Device interface 901 is the entry point into the device manager 252 component to submit requests to one or more devices 203 managed within. The request may be one of, but not restricted to:

1. Load an Audio or Video data stream.

2. Play

3. Pause

4. Stop

5. Change Volume or Equalization

The device manager 250 manages one or more pools 903 of devices 203 through device objects 905. The device objects 905 are unique in the way that they are implemented. A device pool 903 will therefore contain any number of device objects 905 that are implemented in a similar manner. For example, a wave pool 903D will contain a finite number of device objects 905D that were detected by the device manager 507 that respond well to the set of wave APIs offered by the Windows™ operating systems. An ASIO device pool 903C may be more suited to device objects 905C that are detected on UNIX™ operating systems.

Devices 203 managed by the device manager 252 work with video streams 807, audio streams 805 or combiner data streams 815 that are produced by the content manager 250. These streams 815 are compatible with the implementation of the device 203.

A stream 815 is matched with a specific device 203 by assigning a device pool name to the stream 815. Each device pool 903 in the device manager 252 has a name; therefore it is a simple task to find the correct pool 903 for a stream 815. This allows streams 815 to be dynamically reassigned to different device 203 implementations. Depending on the content of the stream 815 (e.g. mono commentary vs. stereo music) it may be more efficient use of computer 7 resources to choose one device 203 implementation over another, even though both implementations are compatible.

Each device 203 has a state, regardless of the implementation. From the point of view of the interface 901, the framework command has no idea of the different possible device 203 implementations, however the device manager 252 does provide through the interface 901, access to a device state 907, such as loading, stopped, playing, paused, dormant, stop pending. The device state 907 is used to report dynamically a condition of a device 203 at any given moment in time.

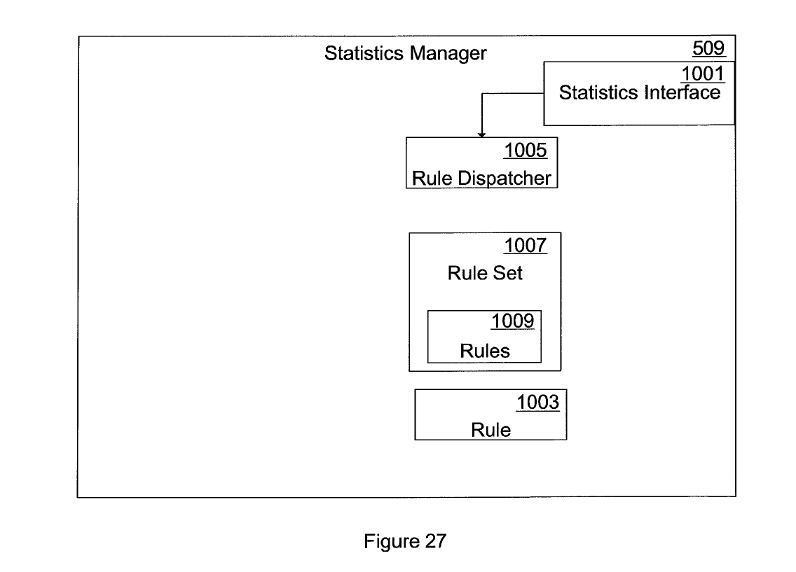

Referring to FIG. 27, the statistics manager 509 component is responsible for receiving at statistics interface 1001 commands defined in the framework command set 403, and executing rules 1003 on a history of previous commands submitted to the statistics manager 509. If a rule 1003 detects a violation, then the condition and violating command is reported in a statistics file. The data stored within the command is used by a rule 1003 to determine if there is a violation of the rule 1003.

The Statistics Manager also maintains a rule dispatcher 1005 that is responsible for executing a rule set 1007 based on the last command submitted. Each rule set 1007 maintains a collection of one or more rules 1009 that validate one or more commands. The types of commands that a collection of rules 1009 operate on define a rule set 1007.

A 1003 rule will examine a command's attribute values to determine if there is a violation. The values are a result of the execution of a command. Because a rule 1003 may be required to evaluate a history of commands submitted to the statistics manager 509, a storage area that maintains this history is allocated and managed by the statistics manager 509.

The statistics manager 509 configuration data is created at initialization by the configuration manager 501. At initialization, the statistics manager 509 is passed this data so that it may set up rule sets 1007 and rules 1009 and start with an empty set of previous commands.

The overall goal of the statistics manager 509 is to allow the customer to monitor application usage based on the rules 1009 that are instantiated and made executable within the active rule set 1007. Based upon the statistics that are generated, the customer may decide to make changes to the system 112 externally to optimize the operation.

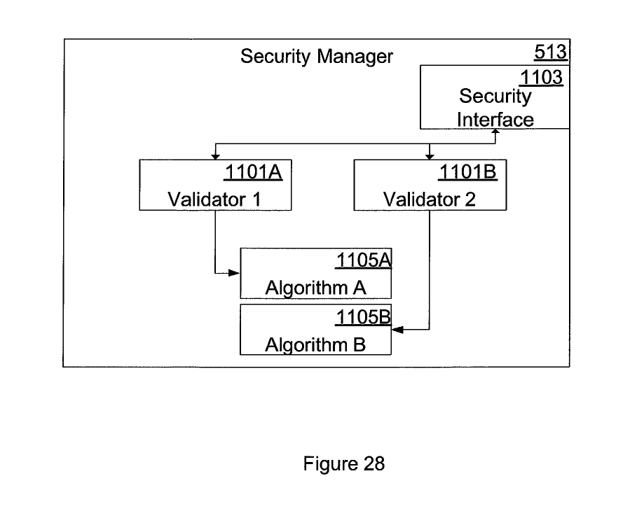

Referring to FIG. 28, the security manager 513 is a simple framework 405 component that has the responsibility of performing security validation checks on behalf of the application using the framework 405 or framework 405 components.

There are one or more validators that are managed by the security manager 513. The choice of validator is dependent upon the request that arrives at security interface 1103.

For example, administrative password validation may require the use of validator 1 1101A to determine if the user entered the proper password. Application license validation may require the use of validator 2 1101B.

Each validator 1101 may use a specific algorithm to implement the validation routine. An example of an algorithm is to derive a MD5 digest string from a string that was passed to the security manager 513 via a command interface.

Example flow charts for an embodiment of a presentation controller application 325 will now be described.

i Initialization

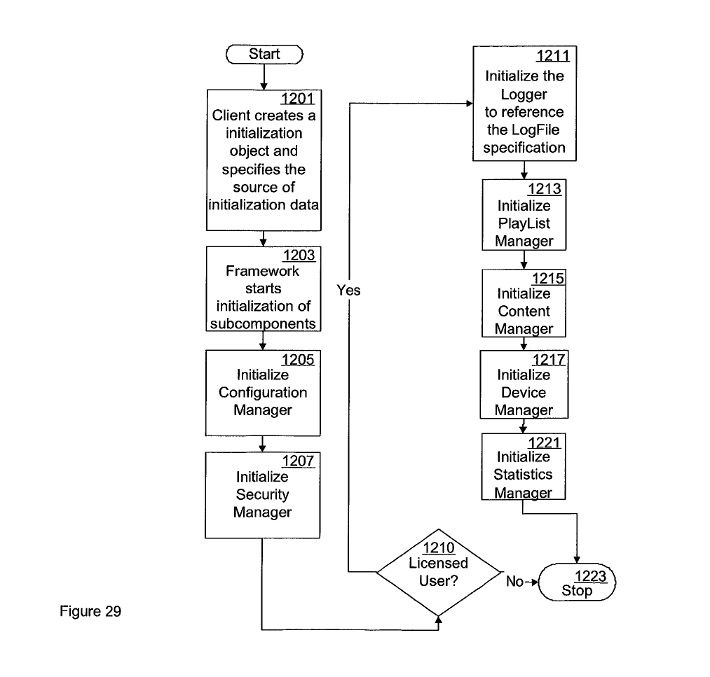

Referring to FIG. 29, the framework 405 must be initialized via an initialization command that the application (client) using the framework 405 creates at 1201. The application using the framework 405 must also provide the command a string to the command that specifies the location of the configuration data.

The framework 405 then processes the command and starts initialization of subcomponents at 1203. An instance of the configuration manager 501 is created and the configuration object is built at 1205. This object dictates how the rest of the system 112 is to be initialized.

The security manager 513 is created 1207 and proceeds to do license validation at 1210. If the license cannot be verified, then processing stops at 1223. Otherwise, initialization of the remaining framework components is carried out.

The logger 511 is told at 1211 where the log file exists based on the logging information found in the configuration object.

An instance of the playlist manager 254 is created at 1213. The playlist manager 254 creates the playlists 128 that are defined in the configuration object If any playlist objects 711 fail to build or validate, the outcome is logged in the logger 511 component.

An instance of the content manager 250 is created at 1215. The initialization task of the content manager 250 is to create the factory that is responsible for creating the stream objects based on audio or video sources.

An instance of the device manager 252 is created at 1217. The device manager 252 will create one or more pools 903 of device objects 905 that share a common implementation. The device objects 905 are left in a dormant state until a request to load a stream arrives in a later transaction.

Finally, an instance of the statistics manager 509 is created at 122 land the statistics object is built. This object dictates what stats are to be logged when a stats request is submitted to the statistics manager 509.

Once all framework 405 components have been initialized, processing stops at 1223.

ii Loading Streams into Devices

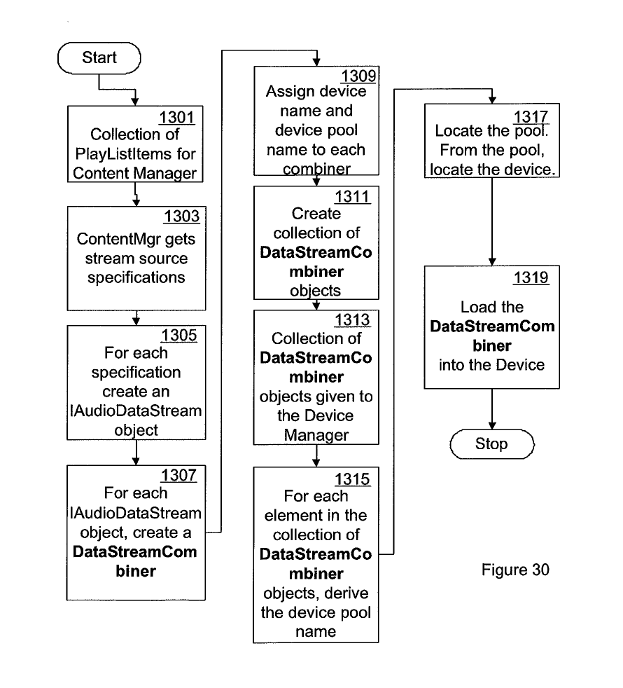

Referring to FIG. 30, the process of loading streams 815 into devices 203 starts at the content manager 505. The content manager 505 is responsible for creating streams 815 that are compatible with the devices 203.

content manager 505 obtains a collection of playlistitems at 1301. The source of each stream 815 may be a file specification, a URL, or a data blob in a database. Each PlayListItem contains one or more PlayItems. A PlayItem contains a stream 815 source specification which is obtained at 1303. The content manager 505 creates at 1305 an IAudioDataStream from each playitem source specification.

Each IAudioDataStream may be assigned to one (mono) or two (stereo) channels. Whether it is one or two channels, the IAudioDataStream must be placed in a DataStreamCombiner so that two or more IAudioDataStream may be combined to achieve channel separation or special processing to achieve a desired effect. In short, each device 203 is assigned one DataStreamCombiner at 1309.

The content manager 505 will create one or more DataStreamCombiners at 1311. Each DataStreamCombiner is assigned to a specific device object in a device pool 903. Therefore, the DataStreamCombiners must be assigned a device pool 903 and device object name. This information originates in the PlayListItem.

The device manager 507 receives the collection of DataStreamCombiners at 1313. Each DataStreamCombiner refers to a device pool 903 and device 203 in which it is to load. The device manager 507 pulls this information from each DataStreamCombiners at 1315 to locate the proper device 203 at 1317. Once the proper device 203 is located, the DataStreamCombiner is loaded into the device 203 at 1319.

iii Controlling Devices

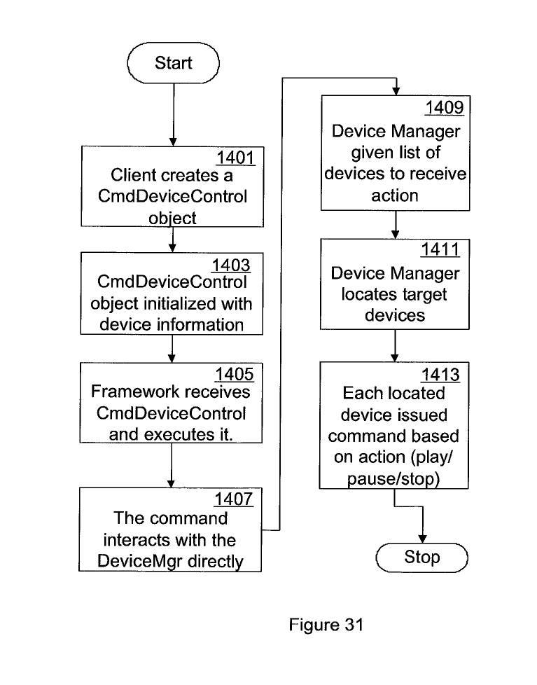

Referring to FIG. 31, the process starts with the interface application 401 using the framework 405 creating a CmdDeviceControl object at 1401. The application 401 using the framework 405 initializes this object at 1403 with the following data:

1. A list of device 203 or pool definitions.

2. A device map 723 that contains the information that maps a pool to a device 203.

3. An action id to indicate play, pause, or stop.

Note that the pool definition mentioned here should not be confused with a device pool 903 definition. The pool definition referred to here is the pool definition that defines a pool of PlayListItems 124. This pool is mapped to a specific device 203 so that all PlayListItems 124 in the pool play through the same device 203.

The framework 405 then executes the CmdDeviceControl at 1405. Within this command, the device manager 252 is accessed and interacted with directly the CmdDeviceControl command at 1407.

Provided with the list of device definitions or pool definitions at 1409, the device map assists in locating at 1411 the device pool and device name that is to perform an action. This action is determined by the action id at 1413 that is also contained within the CmdDeviceControl object.

Each device that is located from the information available is sent the appropriate message based on the action id. If the device is not in the correct state to perform the action, then an error is logged and the action is ignored.

iv Statistics

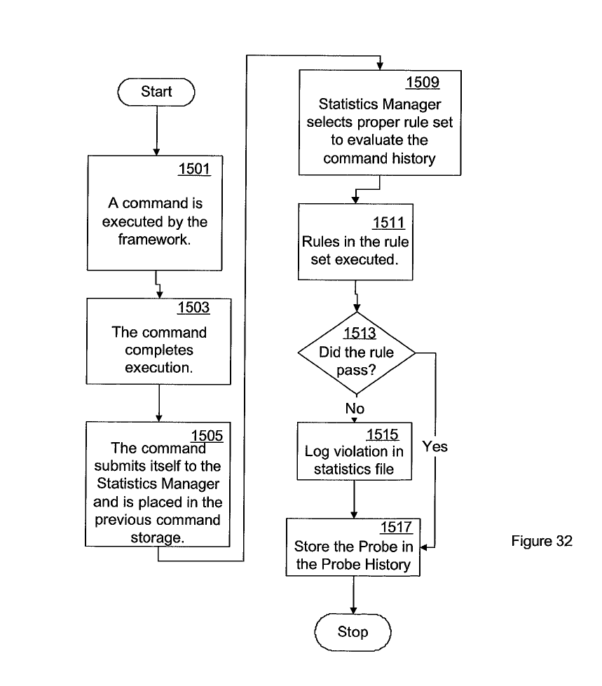

Referring to FIG. 32, the statistics process starts with any framework 405 command submitting itself to the statistics manager 509 at 1501 after the execution of the command.

Once the statistics manager 509 receives a command, a DoExecuteRuleSet function activates the appropriate rule set 1007 based on the last command submitted.

The statistics manager 509 selects rule sets 1007 to evaluate the command at 1509. The command is evaluated by one or more rules 1009 within one or more rule sets 1007 at 1511.

If any given rule 1003 within a rule set 1007 does not validate at 1513, then the rule 1003 will log the violation to a statistics file at 1515.

Once all rules 1009 are executed, the command is stored in a command history list at 1517, as this command may need to be examined in future invocations of the statistics manager 509.

v Streaming

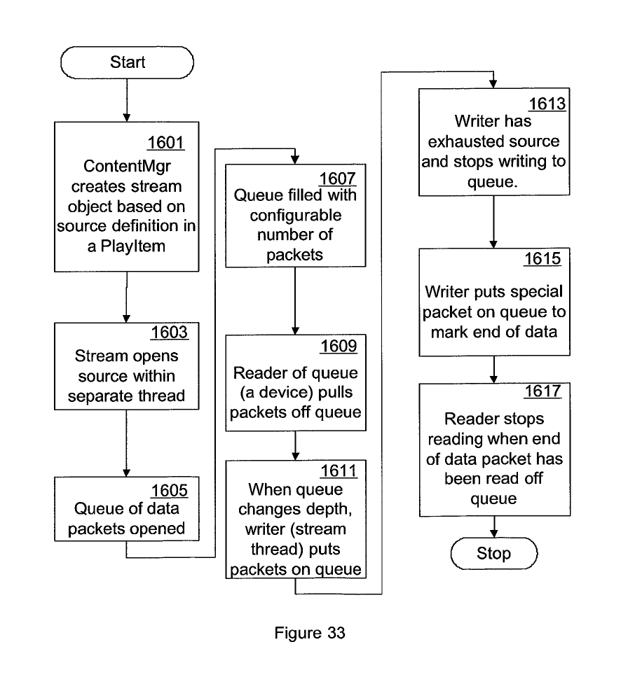

Referring to FIG. 33, streaming makes more efficient use of the computer operating system and permits sharing CPU cycles across multiple threads for more expensive I/O operations.

The process starts at 1601 with the content manager 250 creating a stream object which references a data source referenced within a playitem 719.

The stream object opens at 1603 the source and starts reading the data from it in a separate thread that is created upon creation of the stream object.

A queue is set up at 1605 that is shared with the thread and the entity that reads from the queue. The queue contains packets of data at 1607 that will eventually be read into the device 203 that is to play the data. The depth of the queue and the size of the packets in the queue are configurable values that are set in the global configuration object.

The stream object writer thread reads from the source and writes the data to the queue in the form of packets. When the queue depth has reached its limit, the writer thread stops reading from the source and placing packets on the queue.

The reader reads packets off of the queue at 1609 and formats the packets for the device 203 to play. When the queue depth changes in size at 1611, the writer thread wakes up and starts reading from the source again, to attempt to fill the queue to its maximum depth.

When the source has been exhausted at 1613, the writer thread will stop writing to the queue. A special packet is placed at 1615 on the queue to signal end of data to the reader.

The reader stops reading from the queue at 1617 once the end of data packet has been read.

vi Authentication

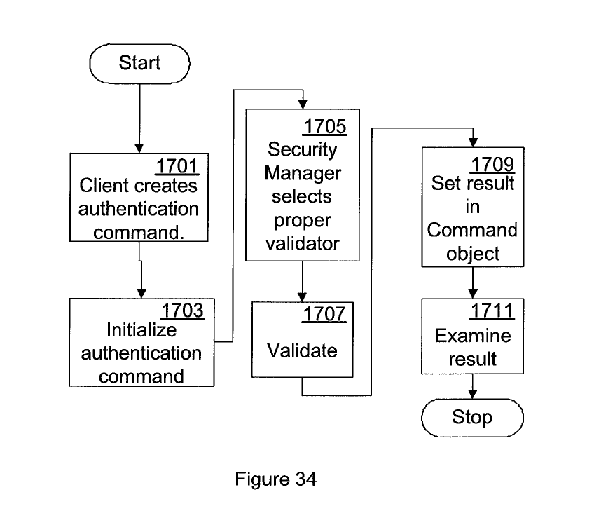

Referring to FIG. 34, the authentication process starts where the application 401 using the framework 405 creates an authentication command at 1701. The command is initialized with a plaintext key and validation type at 1703. The plaintext key may be a password entered by the user.

The security manager 513 receives the request and selects the validator at 1705 based on the type specified in the command object.

The selected validator performs validation at 1707 using the plaintext key as a subject.

The command object stores result of validation internally at 1709 for the application using the framework 405 to examine at 1711.

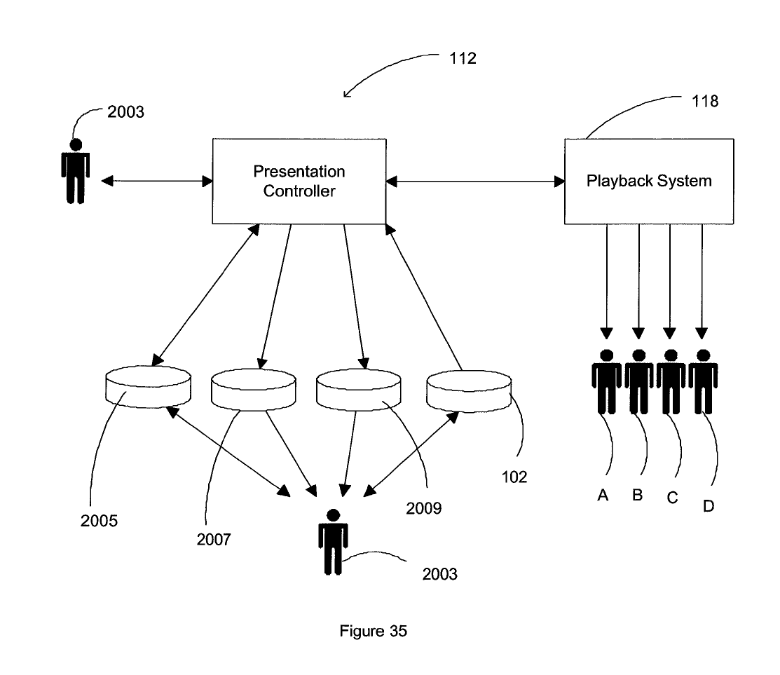

Referring to FIG. 35, a further example is shown of a presentation system 112 including the participants that control and analyze the system, or receive audio/visual data from the system.

An operator 2001 controls the presentation system 112 via the interface application 401 described previously. Typically, the operations the operator 2001 performs may be, but are not restricted to: Play, Pause, Skip, Stop, Reset, change context, change playlist, change volume. In manual installations of the presentation system 112, the operator 2001 provides a scene signal by indicating that a new playitem should be played.

An administrator 2003 controls the presentation system 112 via configuration settings 2005 and digital content 102. The administrator 2003 receives feedback from the presentation system via logs 2007 and statistics 2009 generated by the presentation system 112 during operation.

The playback system 118 may be comprised of audio or video devices, transmitters, combiners, the antenna, and receivers as described previously.

The audience A, B, C, D benefits from the overall system 112 by receiving audio/video content at each audience's choosing.

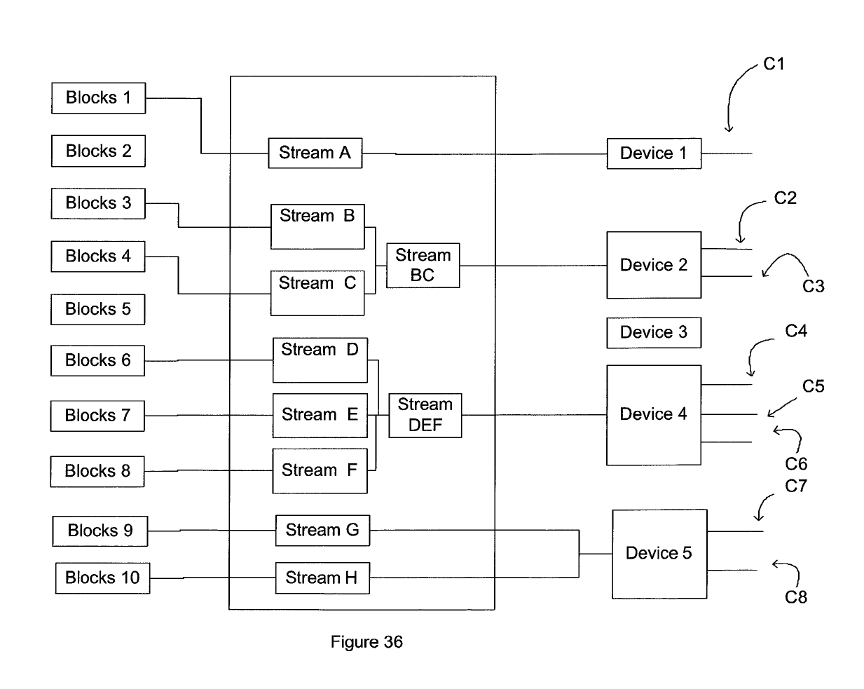

Referring to FIG. 36, a possible relationship between digital presentation blocks 102 and channels C1-8 is further illustrated. The left side shows blocks 1-10 which may represent, for example, physical data files (mp3, wave format), or URL links, or data in a database.

Within each playlist 128, there is an area that describes how to map pools (collections) of blocks 1-10 to channels C1-8.

From each of blocks 1-10, a stream (streams A-H) is created. Depending on the mapping of blocks to channels, groups of streams are combined, for example streams BC or DEF. In the example shown, blocks 2, 5 and device 3 have no mapping.

The streams A, BC, DEF, G, H are then written to the devices 1, 2, 4, 5 which transmit the streams to the appropriate channels according to the specification of the device, for example device 2 decodes the stream B portion of stream BC into channel 2 and the stream C portion into channel 3.

Depending on the provider of the device and its device driver, it is also possible to have devices that receive per channel streams. For example, blocks 9, 10 are represented by streams G and H and are written directly to device 5; device 5 outputs the correct stream to channels 8 and 9 in accordance with its internal configuration.

Details of play list definitions in the preferred embodiment of the presentation controller will now be described.

As has been described, playlists 711 support:

1. Independent playback of playlistitems 715 in pools. In this variation, pools of audio data blocks 102 are assigned to a specific device 203 or a channel of a device 203. Devices 203 that are assigned a pool of playlistitems 715 will operate and vary independently. This type of playlist 711 is identified as a sequence playlist 711 B where the presentation controller traverses the pool sequentially.

2. Context bound playback of playlistitems 715 in pools. In this variation, a context is played back as a group of playlistitems 715, each one assigned to a specific device 203. This type of playlist 711 is identified as a context playlist 711A.

The context bound variation of playback should be regarded as a special case. A playlist 711 that is defined to assign a context name to a collection of playlistitems 715 follows specific rules that will allow a playlist 711 to be interpreted correctly by the presentation controller application 325.

b) XML Representation of a PlayList

The framework 405 supports playlists 711 that are represented in XML (Extensible Markup Language) format.

As mentioned previously, it is not necessary to use XML as past and future programming formats will provide similar overall functionality; however, there are currently a number of benefits in choosing XML to represent playlists:

1. It is a standard supported by a growing community.

2. It is easily understood as it is in plain text, with as descriptive tags and attributes as the implementer chooses. One can edit XML in any text editor. One can view the hierarchy in a browser. There are XML editors, but they vary in degree of usefulness.

3. XML parsers are free. One can obtain a DOM (Document Object Model) or a SAX (Simple APIs for XML) parser that is solid from apache.org or w3.org. There is a C++/Java version for both types. The DOM for C++ loads the tree in memory before letting the client traverse it.

4. It has a validation option. did (Document Type Definition) files can define one or more xml files. When the parser processes an xml, it looks to the dtd for the definition. If the xml file does not follow the dtd, if fails, and tells the program where and why. This is a real bonus for problem determination.

5. It is extensible. Adding elements is trivial.

6. Transmitting an xml playlist 711 (or portion of) across a network 301 can be interpreted as the client receives it (using a SAX parser.) Being text, there are no issues in interpreting binary data across different platforms.

7. It's reliable and fast to implement. Development efforts to extend an in-house grammar are bypassed.

8. One can define different dtd files. Different types of playlists can obey a different set of rules. The parser will pick up any violations.

i The PlayList DTD

A DTD (Document Type Definition) is a means of enforcing rules in an XML document. DTDs are written in a formal syntax that explains precisely which elements and entities may appear in the XML document, and what the elements' contents and attributes are.

Validating parsers compare documents to their DTDs and list places where the document differs from the constraints specified in the DTD. The program can then decide what to do about violations.

Shown here is an example of a PlayList DTD to define a context PlayList 711.

<?xml encoding=“ISO-8859-1”?>
<!--@version: ->
<!ELEMENT playlist (devicelist,contextlist,pool+)>
<!ATTLIST playlist name CDATA #REQUIRED

type (context) #REQUIRED>

<!ELEMENT devicelist (devicedef+)>
<!ELEMENT devicedef EMPTY>
<!ATTLIST devicedef name CDATA #REQUIRED

key CDATA #REQUIRED
poolkey CDATA #IMPLIED
channel (left|right) #IMPLIED>

<!ELEMENT contextlist (contextdef+)>
<!ELEMENT contextdef EMPTY>
<!ATTLIST contextdef name CDATA #REQUIRED

key CDATA #REQUIRED
playonload (true|false) #IMPLIED>

<!ELEMENT pool (playlistitem+)>
<!ATTLIST pool name CDATA #REQUIRED

key CDATA #REQUIRED

buffersize CDATA #IMPLIED>

<!ELEMENT playlistitem (playitem+)>
<!ATTLIST playlistitem contextkey CDATA #REQUIRED

name CDATA #IMPLIED
buffersize CDATA #IMPLIED>

<!ELEMENT playitem EMPTY>
<!ATTLIST playitem role (header|content|trailer) #REQUIRED

```
  name CDATA #IMPLIED
  file CDATA #REQUIRED>
```

To summarize the definition above, the following rules used for context PlayLists 711A:

1. The playlist 711A element must have attributes name and type. The only acceptable value for type is context.

2. There must be one devicelist element that contains one or more devicedef elements.

3. Each devicedef element must contain attributes name and key, and optionally poolkey and channel. If specified, the only acceptable values for channel is left or right.

4. There must be one contextlist element that contains one or more contextdef elements.

5. Each contextdef element must contain attributes name and key, and optionally playonload whose only acceptable values are true and false.

6. There must be one or more pool elements defined, each having one or more playlistitem elements. A pool element must have attributes name and key and optionally buffersize.

7. A playlistitem 715 element must have attributes contextkey and optionally a name and buffersize. A playlistitem 715 element must have one or more playitem elements

8. A playitem 719 element must contain attributes role and file, and optionally name. The only acceptable values for the role attribute are header, content and trailer.

An example of a contextplaylist 711A in xml format is:

```
<?xml version=“1.0” encoding=“iso-8859-1”?>
<!DOCTYPE playlist SYSTEM “contextplaylist.dtd”>
!--@version: -->
<playlist name=“Bateaux London” type=“context”>
  <devicelist>
    <devicedef key=“D1L” channel=“left” name=“WavOut 1/2 Delta-1010”/>
    <devicedef key=“D1R” channel=“right” name=“WavOut 1/2 Delta-1010”/>
    <devicedef poolkey=“P1” key=“D1” name=“WavOut 1/2 Delta-1010”/>
    <devicedef poolkey=“P2” key=“D2” name=“WavOut 3/4 Delta-1010”/>
    <devicedef poolkey=“P3” key=“D3” name=“WavOut 5/6 Delta-1010”/>
    <devicedef poolkey=“P4” key=“D4” name=“WavOut 7/8 Delta-1010”/>
  </devicelist>
  <contextlist>
    <contextdef key=“C1” name=“1 Safety Message”/>
    <contextdef key=“C2” name=“2 Whitehall Court on the right”playonload=“true”/>
    <contextdef key=“C3” name=“3 Houses of Parliament”/>
    <contextdef key=“C4” name=“4 Downstream through Westminster Bridge”/>
  </contextlist>
  <!-- English and German Pool -->
  <pool name=“English and German” key=“P1” buffersize“56000”>
    <playlistitem contextkey=“C1” buffersize=“28000” name=“eg1 optional display text”>
      <playitem role=“header” file=“c:ΔdataΔegΔeg1h.mp3”/>
      <playitem role=“trailer” file=“c:ΔdataΔegΔeg1t.mp3”/>
    </playlistitem>
    <playlistitem contextkey=“C2”>
      <playitem role=“content” file=“c:ΔdataΔegΔeg2c.mp3” name=“eg2c optional display text”/>
    </playlistitem>
    <playlistitem contextkey=“C3”>
      <playitem role=“content” file=“c:ΔdataΔegΔeg3c.mp3” name=“eg3c optional display text”/>
    </playlistitem>
    <playlistitem contextkey=“C4”>
      <playitem role=“header” file=“c:ΔdataΔegΔeg4h.mp3” name=“eg4h optional display text”/>
      <playitem role=“content” file=“c:ΔdataΔegΔeg4c.mp3” name=“eg4c optional display text”/>
      <playitem role=“trailer” file=“c:ΔdataΔegΔeg4t.mp3” name=“eg4t optional display text”/>
    </playlistitem>
  </pool>
  <!-- French and Portuguese Pool —>
  <pool name=“French and Portuguese”key=“P2” buffersize=“56000”>
    <playlistitem contextkey=“C1” buffersize=“28000” name=“fp1 optional display text”>
      <playitem role=“header” file=“c:ΔdataΔfpΔfp1h.mp3”/>
      <playitem role=“trailer” file=“c:ΔdataΔfpΔfp1t.mp3”/>
    </playlistitem>
    <playlistitem contextkey=“C2”>
      <playitem role=“content” file=“c:ΔdataΔfpΔfp2c.mp3” name=“fp2c optional display text”/>
    </playlistitem>
    <playlistitem contextkey=“C3”>
      <playitem role=“content” file=“c:ΔdataΔfpΔfp3c.mp3” name=“fp3c optional display text”/>
    </playlistitem>
    <playlistitem contextkey=“C4”>
      <playitem role=“header” file=“c:ΔdataΔfpΔfp4h.mp3” name=“fp4h optional display text”/>
      <playitem role=“content” file=“c:ΔdataΔfpΔfp4c.mp3” name=”fp4c optional display text”/>
      <playitem role=“trailer” file=“c:ΔdataΔfpΔfp4t.mp3” name=“fp4t optional display text”/>
    </playlistitem>
  </pool>
  <!-- Italian and Spanish Pool ->
  <pool name=“Italian and Spanish”key=“P3” buffersize=“56000”>
    <playlistitem contextkey=“C1” buffersize=“28000” name=“is1 optional display text”>
      <playitem role=“header” file=“c:ΔdataΔisΔis1h.mp3”/>
      <playitem role=“trailer” file=“c:ΔdataΔisΔis1t.mp3”/>
    </playlistitem>
    <playlistitem contextkey=“C2”>
      <playitem role=“content” file=“c:ΔdataΔisΔis2c.mp3” name=“is2c optional display text”/>
    </playlistitem>
    <playlistitem contextkey=“C3”>
      <playitem role=“content” file=“c:ΔdataΔisΔis3c.mp3” name=“is3c optional display text”/>
    </playlistitem>
    <playlistitem contextkey=“C4”>
      <playitem role=“header” file=“c:ΔdataΔisΔis4h.mp3” name=“is4h optional display text”/>
      <playitem role=“content” file=“c:ΔdataΔisΔis4c.mp3” name=“is4c optional display text”/>
      <playitem role=“trailer” file=“c:ΔdataΔisΔis4t.mp3” name=“is4t optional display text”/>
    </playlistitem>
  </pool>
  <!-- Japanese and Dutch Pool —>
  <pool name=“Japanese and Dutch”key=“P4”>
    <playlistitem contextkey=“C1” buffersize=“28000” name=“jd1 optional display text”>
      <playitem role=“header” file=“c:ΔdataΔjdΔjd1h.mp3”/>
      <playitem role=“trailer” file=“c:ΔdataΔjdΔjd1t.mp3”/>
    </playlistitem>
    <playlistitem contextkey=“C2”>
      <playitem role=“content” file=“c:ΔdataΔjdΔjd2c.mp3” name=“jd2c optional display text”/>
    </playlistitem>
    <playlistitem contextkey=“C3”>
      <playitem role=“content” file=“c:ΔdataΔjdΔjd3c.mp3” name=“jd3c optional display text”/>
    </playlistitem>
    <playlistitem contextkey=“C4”>
      <playitem role=“header” file=“c:ΔdataΔjdΔjd4h.mp3” name=“jd4h optional display text”/>
      <playitem role=“content” file=“c:ΔdataΔjdΔjd4c.mp3” name=“jd4c optional display text”/>
      <playitem role=“trailer” file=“c:ΔdataΔjdΔjd4t.mp3” name=“jd4t optional display text”/>
    </playlistitem>
</pool>
</playlist>
```

A sample DTD for a sequenceplaylist 711B where the rules are not so stringent to allow for sequential navigation through playlistitems 715 that are associated with one or more devices 203 or pools without being bound to contexts.

<?xml encoding=“ISO-8859-1”?>
<!-- @version: ->
<!ELEMENT playlist (devicelist,pool+)>
<!ATTLIST playlist name CDATA #REQUIRED

type (sequence) #REQUIRED>

<!ELEMENT devicelist (devicedef+)>
<!ELEMENT devicedef EMPTY>
<!ATTLIST devicedef name CDATA #REQUIRED

key CDATA #REQUIRED
poolkey CDATA #IMPLIED
channel (left|right) #IMPLIED>

<!ELEMENT pool (playlistitem+)>
<!ATTLIST pool name CDATA #REQUIRED

key CDATA #REQUIRED

buffersize CDATA #IMPLIED>

<!ELEMENT playlistitem (playitem+)>
<!ATTLIST playlistitem name CDATA #IMPLIED

buffersize CDATA #IMPLIED>

<!ELEMENT playitem EMPTY>
<!ATTLIST playitem role (header|content|trailer) #REQUIRED

```
  name CDATA #IMPLIED
  file CDATA #REQUIRED>
```

c) Elements of a PlayList

The following are objects that are created as a result of loading a playlist 711. Some of the objects described are derived from the content of the external playlist 711 representation, and need not be explicitly stated in the external playlist 711 representation.

i PlayList

A playlist 711 stores all the elements described below.

A playlist 711 has the following attributes:

1. A display name.

2. A file specification

3. A type (context/sequence)

ii PlayListItem

A playlistitem 715 stores a reference to one or more playitems 719.

A playlistitem 715 must contain one or more of a header, content and/or trailer type playitem 719.

A playlistitem 715 has the following attributes:

1. A display name.

2. A pool key to identify in which pool it exists.

3. A context key to identify in which context it exists. This is required for contextplaylists 711A only.

4. A buffer size.

5. A pool position for iteration functions.

iii PlayItem

A playitem 719 is a basic element of a playlist 711. A playitem 719 has the following attributes:

1. Type. A playitem 719 can be identified as a header, content, or trailer segment.

2. A source of data. This is the location of an audio/video data stream. This can be a file name, or URL.

3. The display name.

I Header Type

From the example described previously with reference to FIG. 11, the header 126A is the data segment that is played before the content portion 126B. It may typically take on the form of an advertisement (e.g. a short Visa plug.)

A header 126A should typically be kept short in duration as it is meant to act as an introduction to the content data 126B and contain a short message to be delivered to the listener.

While a header 126A is playing, the device 203 is in a PLAYING state and the remaining time reflects the combined remaining time of the header 126A and content segment 126B.

II Content Type

A content type playitem 126B represents the main content of the playitem 124 and may be a commentary of an attraction, or a music track.

While a content segment 126B is playing, the device 203 is in a PLAYING state and the remaining time reflects the remaining time of the content segment 126B.

III Trailer Type

The trailer 126C is the data segment that is played after the header 126A or content 126B. It may typically take on the form of music filler. Trailer data 126C will not be played in an endless loop, and therefore should be of sufficient duration to fill the amount of time desired. When a trailer 126C finishes, playback of a trailer 126C can resume until an event occurs that causes the presentation controller application 325 to move to the next playlistitem 715(e.g. a scene signal such as a context which is flagged to play on load, or the operator hits play).

While a trailer segment 126C is playing, the device 203 is in a PLAYING_IDLE state and the remaining time is not applicable, as this is a state that should be interrupted prior to moving to a DORMANT state. A DORMANT state is a device 203 that is detected, but closed with nothing scheduled to play.

iv PoolDef

A pool represents a collection of playlistItems 715 that may be assigned to a device 203 or a channel c1, etc. The pool has no knowledge which device 203 it may be mapped to, but the device definition may contain a Pool key.

A pool definition has the following attributes:

1. A display name.

2. A pool key that is referenced in the device definition.

3. A buffer size.

v Sequence

Sequence objects are stored in a sequenceplaylist 711B. A pool key is used to acquire a given sequence in a sequenceplaylist 711B.

A sequence contains a hash of playlistitems 715 keyed by their positions in the pool. A sequence also contains the pool definition that describes the sequence.

A sequence has the following attributes:

1. A hash of playlistitems 715.

2. A pool definition.

vi ContextDef

A context is a grouping of playlistitems 715 that are assigned to multiple devices 203 or channels that are to be played simultaneously. A context definition is only applicable in contextplaylists 711A.

A context definition has the following attributes:

1. A display name.

2. A context key.

3. A play on load flag.

vii ContextItem

A contextitem 727 is one element of a context map 725. This item stores a list of PlayListItems 715 that are assigned to a specified context. A contextitem 727 is only applicable in contextplaylists 711A.

A contextitem 727 has the following attributes:

1. A list of playlistitems 715 that belong to the context.

2. A context definition.

3. A context definition that represents the next context in the context order.

4. A context definition that represents the previous context in the context order.

viii ContextMap

The contextmap 725 stores a hash of contextitems 727. Contextitems 727 are keyed by the context keys defined in the playlist 711A data file. A contextmap 725 is only applicable in contextplaylists 711A.

A contextmap 725 has the following attribute:

1. A hash of contextitems 727 keyed by a context key.

ix DeviceDef

The devicedef is the object that defines a device 203 within the playlist 711. It assists in the mapping of pools of playlistitems to the physical device 203.

A devicedef has the following attributes:

1. A device name.

2. A device key.

3. A pool key. Not all devices need to be mapped to a pool.

4. A channel (left/right/center (default), etc.).

x DeviceMap

The devicemap 723 is used to map devices to pools. The mapping is defined in each playlist 711 within the devicedef entity. The devicemap contains a hash of devicedefs that must:

1. Contain pool keys.

2. Have a corresponding physical device as detected by the device manager 252.

There are two mechanisms in which to locate a devicedef within the hash. The first is to provide a pool key. If the pool is mapped to a device 203, then the corresponding devicedef will be returned.

The second lookup mechanism is to provide a device key. It may seem odd to use adevicedef device key to obtain the same devicedef, however this is useful when given a list of devicedefs, the map 723 is only to report those that have a pool key, and a corresponding physical device 203 on the system.

xi A Note on Buffer Size

There are a number of places to define buffer size:

1. In the configuration file.

2. In a Pool

3. In a playlistitem 711

The order of precedence is simple. If a playlistitem 711 does not define a buffer size then it is taken from the pool definition. If a pool definition does not define a buffer size then it is taken from the configuration file.

Scheduling Header, Content, and Trailer Segments

xii Scheduling Playback of Segments

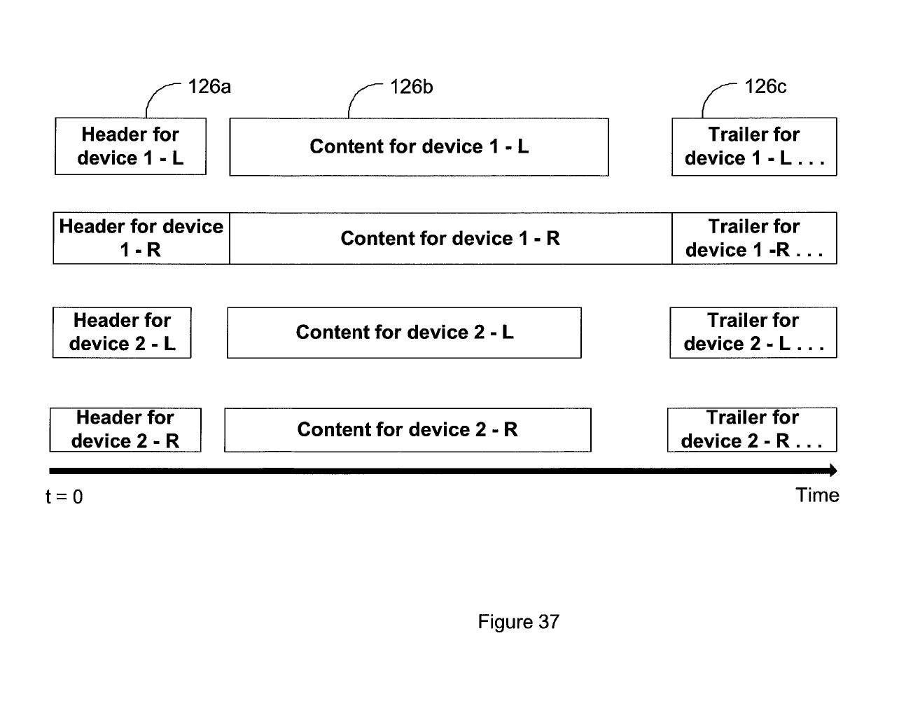

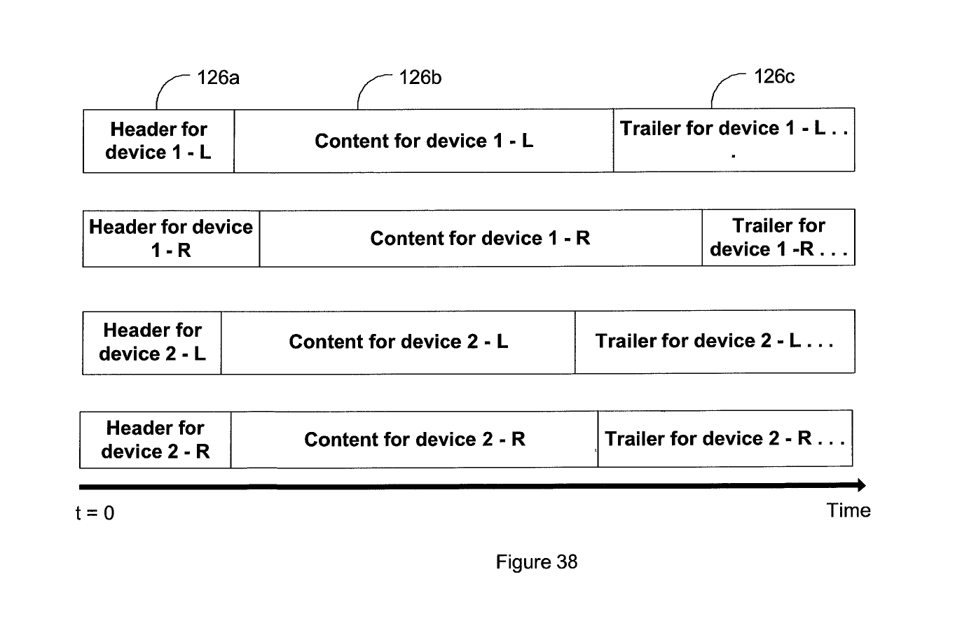

Referring to FIGS. 37 and 38, because header 126A and content 126B defined within a context can be of varying length (due to language translation), there are two choices on how to synchronize playback of header 126A, content 126B and trailer 126C segments:

1. Synchronize all header 126A segments such that all content 126B segments start at the same time. Synchronize all content 126B segments such that all trailer 126C segments start at the same time. (FIG. 37)

2. Do not provide any synchronization between headers 126A and content 126B between channels. When a header 126A ends, commence the content 126B. When the content 126B ends, commence the trailer 126C. This is considered contiguous playback of segments. (FIG. 38)

From FIG. 37, we see a flaw in that there is empty space between the segments 126A, 126B, 126C, and this is what the audience member 100 will perceive. Device 1-R is the anchor that determines the time of playback of the content 126B and trailer 126C segments of other devices 203 because the segments assigned to this device 203 happens to be the longest. The listener of another device 203 will perceive gaps and may misinterpret these gaps as the end of the program, and remove the listening device.

From FIG. 38, we recognize that all segments 126A, 126B, 126C are tightly bound together, and that there is as a result, continuity for the audience member 100. This is the preferred solution.

From this, one can see the reason for trying to keep header segments 126A reasonably short, so that content 126B starts at approximately the same time for all listeners.

xiii Reporting Remaining Time

Remaining time is reported on the sum of header 126A and content 126B time. If a header 126A is 8 seconds and a content 126B 4 minutes, then the total remaining time shown is 4 minutes and 8 seconds.

Once a device 203 starts to play trailer 126C data, remaining time is meaningless as a trailer 126C is only meant to act as filler and can be interrupted any time when the operator 2001 advances the presentation controller application 325 to load the next context.

Navigating and Loading PlayListItems

This section describes the events that occur when a request is made to load a collection of playlistitems 715 in a device 203.

In the preferred embodiment, devices 203, or channels of a device 203, have no knowledge of playlistitems 715. A device 203 interacts with a contentstream object only.

xiv Next, Previous, or Random Selection

In the preferred embodiment of the interface application 401, the operator 2001 of the presentation controller application 325 can move from one data segment 124 to the next by using the controls on any of the system, product, pool, or device views of the presentation controller application 325.

The system view offers control to the operator 2001 to randomly load playlistitems 715 associated with a context, provided that the playlist 711 is of a context type.

To review the purpose of each view in the presentation controller application 325:

System View:

The system view displays one set of buttons that control the playback and positioning of all pools that are mapped to devices 203.

In a context playlist 711A, the skip, stop, and reset buttons as well as the context selection control forces the position of individual pools to line up with the context selected. This feature addresses the case where an operator 2001 may place a sequence out of synch with the current context by issuing a skip, stop, or reset on either the product or device views. If play back is out of synch, then pressing skip, stop, or reset buttons on the system view realigns the sequences with the resultant context.

In playlists 711B that are not context bound, skip moves sequence positions forward or back independently. That is to say that each sequence that is mapped to an individual device 203 will respond and reposition itself according to its current position.

Product View:

The product view identifies devices associated with a piece of hardware and controls them as a group.

It differs slightly from other views as a set of buttons control pools mapped to a set of devices that are specified by the respective device keys. .

Each playlist may specify one or more product groups. An example of product groups specification in XML would be the following:

<ProductGroup name=”Delta 1010 - board 1”>

<ProductGroupItem devicekey=”D1”/>
<ProductGroupItem devicekey=”D2”/>
<ProductGroupItem devicekey=”D3”/>
<ProductGroupItem devicekey=”D4”/>

</ProductGroup>
<ProductGroup name=” Delta 1010 - board 2”>

<ProductGroupItem devicekey=”D5”/>
<ProductGroupItem devicekey=”D6”/>
<ProductGroupItem devicekey=”D7”/>
<ProductGroupItem devicekey=”D8”/>

</ProductGroup>

Then two sets of controls will be displayed on the Product view. The first set of buttons control the devices 203 all of which are referenced by the device keys specified individually in each productgroupitem. In the example above, one set of buttons will control devices 203 that have device keys D1, D2, D3, D4. Another set of buttons will control devices 203 that have device keys D5, D6, D7, D8.

Pool View:

The pool view identifies devices 203 associated with one or more pools and controls them as a group.

It differs slightly from other views as a set of buttons control pools mapped to a set of devices 203 that all have a name that starts with a sub-string specified in the player.ini file.

Each play list may specify one or more pool groups. An example of pool groups specification in XML would be the following:

<PoolGroup name=”Scandinavian Languages”>

<PoolGroupItem poolkey=”P1”/>
<PoolGroupItem poolkey=”P3”/>

</PoolGroup>
<PoolGroup name=”Asian Languages”>

<PoolGroupItem poolkey=”P2”/>
<PoolGroupItem poolkey=”P5”/>

</PoolGroup>

Then two sets of controls will be displayed on the pool view. The first set of buttons control the devices 203 which are mapped to pool keys P1 and P3. The second set of buttons control the devices 203 which are mapped to pool keys P2 and P5.

In the example, the first set of buttons will control the Germanic languages (say, Finnish and Norwegian). The Pool represented by pool key P1 may represent Finnish and pool key P3 may represent Norwegian. The second set of buttons will control the Asian languages (say, Chinese and Korean). The Pool represented by pool key P2 may represent Chinese and pool key P5 may represent Korean.

Device View:

The device view controls devices 203 independently. For every device 203, there is a group of buttons that control that device 203.

Within the framework, mono data segments are combined on the fly to create a split mono AudioStream . This eliminates the need to create split mono audio segments, which has a huge disadvantage of forcing language A on the left, language B on the right, and languages A and B on any one device 203 at all times.

The device view controls the left and right channels of a device 203. It may be adapted to allow for play, pause, skip, stop, reset of left or right channels independently.

For playlists 711 that are not context bound, controlling playback for a channel independently may have some value in applications where tourists are listening to commentary and control which playlistitem 715 is to be played next.

The following table shows the possible navigation operations through the playlist 711 to load devices 203 with the desired playlistitems 715. The command hierarchy that is the interface into the framework 405 offers one command class called CmdLoad.

The interaction with this class to achieve the desired result is described in terms of method calls on the object to initialize it with the correct criteria. For convenience, and to anticipate more load parameters in the future, the load parameters are neatly wrapped in a LoadParam object.

| | | Actions | | |
|---|---|---|---|---|
| | | Skip Forward | Skip Back | Random |
| View | System | LoadParams: | LoadParams: | LoadParams: |
| | | DIRECTION_FWD | DIRECTION_BACK | contextDef |
| | | | | This is only applicable to |
| | | | | PlayLists that are context bound. |
| | | | | The view is responsible for |
| | | | | obtaining a list of contexts |
| | | | | definitions from the Framework |
| | | | | to support random access. |
| | Product | LoadParams: | LoadParams: | LoadParams: |
| | | DIRECTION_FWD | DIRECTION_BACK | PoolPosition |
| | | PoolDefList | DeviceDefList | |
| | Pool | LoadParams: | LoadParams: | LoadParams: |
| | | DIRECTION_FWD | DIRECTION_BACK | PoolPosition |
| | | PoolDefList | PoolDefList | |
| | Device | LoadParams: | LoadParams: | LoadParams: |
| | | DIRECTION_FWD | DIRECTION_BACK | PoolPosition. |
| | | DeviceDefList | DeviceDefList | |

Note that the stop command issues a forward command in the background. The reset command causes the current context to be the first defined in the list of contexts, so in fact it is the equivalent to a random motion where the context name is the first defined in the list of contexts.

The design requires that a client of the Framework is able to get device, pool, and context definition lists as well as the current DeviceMap object to determine what is a valid definition to work with.

d) PlayList Rule and Recommendations

This section describes example rules and recommendations for configuring generic, context and sequence playlists 711 used with the preferred embodiment of the presentation controller 114. Note that any rule or recommendation that applies to a sequence playlist 711B also applies to a context bound playlist 711A as a contextplaylist is of type sequenceplaylist.

The rules and recommendations stated here are implemented in code. The XML parser does not validate the rules that are defined here.

If any of the following rules fail, the playlist 711 will not load. If any of the recommendations are not followed, a warning is logged.

i Rules for a Generic PlayList

1. Device keys defined in devicedefs must be unique.

2. Pool keys defined in devicedefs must be unique.

3. There must be at least one devicedef entry in the devicemap. In order for a devicedef object to appear in the devicemap, it must have a pool key defined, and the physical device must exist.

ii Rules for a Sequence PlayList

1. A stereo audio data file referenced by a playitem 719 may not be assigned to only one channel of a device 203.

2. There must be a pool for any devicedef that specifies a pool key. iii Rules for a Context Bound PlayList

1. The context list must have unique context keys.

2. Each playlistitem 715 in a context must specify a unique and valid context key.

3. For each contextitem in the contextmap, the number of playlistitems 715 must be the same.

4. All pools represented by sequences in sequenceplaylists should have the same depth. For example, if a sequence one has 35 entries, then all other sequences defined must have 35 entries.

5. Each context must have the same depth. For example, if context 1 has five playlistitems 715, then the remaining contexts must have five playlistitems 715.

iv Recommendations for a Sequence PlayList

1. Pools should contain playlistitems 715 that reference data sources that are alike in format (i.e. all are either MP3, or wave format).

2. Trailer type playitems 126C are not be played in an endless loop, and therefore should be of sufficient duration to fill the amount of time desired. It is not likely that the audience member 100 will want to listen to a trailer segment 126C for too long, and may remove the ear phone before the segment has completed.

3. Header type playitems 126A should be kept short in duration.

4. If assigning two pools to one device 203 (one pool gets assigned to the left, and the other assigned to the right), then the buffer sizes for each parallel element must be identical.

This condition can be detected by the content manager component 250 and the buffer size will be adjusted to match the largest of the two.

v Recommendations for a Context Bound PlayList

1. If a playitem 711 within a context defines a header 126A, then all playitems 711 within the context should have a header 126A. The same applies with a trailer 126C. In other words, when specifying a header/content/trailer combination in a playlistitem 715, each playlistitem 715 in a given context should have the same combination of header/content/trailer playitems 715.

Referring to FIG. 39, a method of context hashing for an operator 2001 guided tour will now be described.

i Use Case

When an operator 2001 selects a context at random and skips to that context, the playlist 711 managed by the playlist manager 254 will efficiently load the target context without having to do an exhaustive search to find it.

The operator 2001 selects a context definition 2201 by name from a list of context definitions and interacts with the application 401 to skip to the chosen context definition 2201.

Alternatively, an operator 2001 may skip forward or back through context definitions as if they appeared in a sequence.

ii Virtual sequence of context items

Context items 727 are not stored as a sequence of items in a data structure that is sequential in nature such as an array or list. Lists and arrays have a cost associated with them in traversal operations. Arrays are expensive to dynamically increase or decrease in size.

The motivation for avoiding a sequential data structure implementation lies in the requirement to reference any context item 727 in a playlist 711 and not incur the overhead of an exhaustive search to locate it.

The requirement also exists whereby a sequential type traversal is made at the context definition level in a playlist 711.

The ability to access an element of a collection of context items 727 as if it were an element of a sequential list, without actually implementing a sequential data structure is achieved. We may consider this a virtual sequence data structure.

iii Implementation

Every context item (for example 2200) contains the following information:

1. A reference 2203 to the current context definition in a virtual sequence of context items.

2. A reference 2205 to the next context definition in a virtual sequence of context items.

3. A reference 2207 to the previous context definition in a virtual sequence of context items.

4. A reference 2209 to a list of playlistitems 711.

A context definition 2201 is an entity that has a name 2211 and a context key 2213. The key 2213 is used to look up the full context item definition 2201 in a context map 2214. The name 2211 may be used for display by any application 401 that stores the context definition 2201.

An application 401 may ask the framework 405 to position a playlist 711 to a random context by passing the context definition 2201 associated with that position. The playlist 711 obtains a specific context map lookup key 2215 from the context definition 2201 and uses the key 2213 to lookup a resultant context item 2216 from the context map 2214. From the resultant context item 2216, a list of playlistitems 715 may be referenced. It is the playlistitems 715 that store one or more references to physical audio data sources (blocks 102 therein).

The context map 2214 is implemented by encapsulating a hash table and publishing methods that operate on the internal hash table. The hash table stores context items 727 that are keyed by context definition lookup keys.

To simulate sequential lookup (when the operator 2001 skips forward or back through a playlist 711), each context item (2200) references its next or previous neighbor in a context definition. Should a skip forward request be received by a playlist 711, the current context item 2200 (stored in the playlist 711) is queried for the “next” context definition. The “next” context definition has an internal lookup key, which is used to query the context map 2214 for the next context item 2216. When obtained, the next context item 2216 is stored as the current context item 2200 in the playlist 711. Throughout this sequence traversal type operation, an exhaustive search is never performed by the playlist 711 and the application 401 does not need to know what its current context is to perform the next or previous skip operations.

It will be understood by those skilled in the art that this description is made with reference to the preferred embodiment and that it is possible to make other embodiments employing the principles of the invention which fall within its spirit and scope as defined by the following claims.

We claim:

1) A presentation controller for simultaneously playing a plurality of digital presentation blocks to one or more channels, each channel driving one or more presentation contrivances, the presentation contrivances presenting to a plurality of audiences, the presentation controller comprising:
a A plurality of device definitions,
b. A plurality of pools of play list items, each play list item specifying one or more play items, each play item specifying one of the digital presentation blocks,
Wherein each device definition defines a group of one or more channels and defines a pool of play list items for playing to the defined group, and
Wherein the presentation controller is able to redefine the pool of a device definition.

2) The presentation controller of claim 1, wherein the channels are contained within one or more devices and each device definition defines a group of one or more channels by defining one or more channels within one or more devices.

3) The presentation controller of claim 1, wherein the presentation controller plays play list items sequentially within a pool.

4) The presentation controller of claim 1, further comprising a plurality of context definitions, each context definition defines a play list item for each pool, the presentation controller playing concurrently the defined play list items for each context definition.

5) A multi-channel transmission and receiving system for the broadcast of pre-programmed information in varied languages, where each pre-programmed language is digitized and saved as a data file that is called by a main program in a computer when required, where the main program is programmed to respond to external or time events that determine which data files are to be used and output to a digital to analog converter and/or de-multiplexer, where each analog channel is sent to a transmitter tuned to a channel specific for the use of the analog signal, where transmitter outputs are combined via a tuned series of filters to an antenna , where the receiver is portable, and designed to receive the transmitted frequencies and comprises a channel select switch in the receiver determines which of the transmitter frequencies to receive, hereby determining which language to receive.

6) A multi-channel transmission system as described in claim 5 wherein the computer is controlled by specific GPS or location data that guides the computer program to select the appropriate files for that specific geographic zone or site.

7) A multi-channel transmission system as described in claim 5 wherein the data files are output to the computer port as serial data, whereby the serial data is re-programmed via means of digital signal processing and transmitted as Time Division Multiple Access via a spread-spectrum frequency hoping transmitter and where the receiver is capable of receiving the wireless signal and de-coding the appropriate channel via a selector switch.

8) A presentation system comprising:
a plurality of digitized versions of a scene;
one or more physical devices for playing digital content to one or more channels; and
a presentation controller for directing respective digitized versions of the scene to a particular channel of a physical device for synchronized playing of the respective versions;
the presentation controller combining those versions that are directed to a particular physical device, the combination occurring at the time the versions are to be played.

9) A presentation system comprising:
digital content arranged as a set of one or more scenes, each scene having one or more versions;
one or more physical devices for playing digital content to one or more channels; and
a presentation controller for directing respective versions of a scene to a particular channel of a physical device for synchronized playing of the respective versions;
the presentation controller combining those versions that are directed to a particular physical device, the combination occurring at the time the versions are to be played;
and the presentation controller directing the versions for a particular scene on receipt of a scene signal.

10) The presentation system of claim 9 wherein each version contains content for a scene in a different language.

11) The presentation system of claim 9, wherein the presentation controller directs the version of a next scene on a list of scenes upon receipt of the scene signal.

12) The presentation system of claim 9, wherein the presentation controller directs the versions of a particular scene indicated by the scene signal upon receipt of the scene signal.

13) A method for simultaneously playing a plurality of digital presentation blocks to one or more channels, each channel driving one or more presentation contrivances, the presentation contrivances presenting to a plurality of audiences, the method comprising:
a Accessing one of a plurality of device definitions,
b. Accessing a plurality of pools of play list items, each play list item specifying one or more play items, each play item specifying one of the digital presentation blocks,
Wherein each device definition defines a group of one or more channels and defines a pool of play list items for playing to the defined group, and
Wherein the presentation controller is able to redefine the pool of a device definition.

14) A method for simultaneously playing a plurality of digital presentation blocks to one or more channels, each channel driving one or more presentation contrivances, the presentation contrivances presenting to a plurality of audiences, the method comprising:
Having available for access a plurality of digitized versions of a scene;
Having available for access one or more physical devices for playing digital content to one or more channels; and
Utilizing a presentation controller for directing respective digitized versions of the scene to a particular channel of a physical device for synchronized playing of the respective versions;
the presentation controller combining those versions that are directed to a particular physical device, the combination occurring at the time the versions are to be played.

15) A method for simultaneously playing a plurality of digital presentation blocks to one or more channels, each channel driving one or more presentation contrivances, the presentation contrivances presenting to a plurality of audiences, the method comprising:
Having digital content arranged as a set of one or more scenes, each scene having one or more versions;
Having one or more physical devices for playing digital content to one or more channels; and
Utilizing a presentation controller for directing respective versions of a scene to a particular channel of a physical device for synchronized playing of the respective versions;
the presentation controller combining those versions that are directed to a particular physical device, the combination occurring at the time the versions are to be played;
and the presentation controller directing the versions for a particular scene on receipt of a scene signal.
